(19) United States
(12) Patent Application Publication
(10) Pub. No.: US 2017/0171063 A1
(43) Pub. Date: Jun. 15, 2017

(54) METHOD, APPARATUS AND NON-TRANSITORY COMPUTER-READABLE STORAGE MEDIUM

(71) Applicant: FUJITSU LIMITED, Kawasaki-shi (JP)

(72) Inventors: Tetsuya Nishi, Kawasaki (JP); Shinji Kikuchi, Yokohama (JP)

(73) Assignee: FUJITSU LIMITED, Kawasaki-shi (JP)

(21) Appl. No.: 15/350,160

(22) Filed: Nov. 14, 2016

(30) Foreign Application Priority Data
Dec. 15, 2015 (JP) 2015-244077

(51) Int. Cl. H04L 12/703; H04L 12/751; H04L 29/06; H04L 12/733; H04L 12/721; H04L 5/00

(52) U.S. Cl. CPC H04L 45/28; H04L 45/26; H04L 5/0055; H04L 69/22; H04L 45/20; H04L 45/02

(57) ABSTRACT

A method includes relaying a first packet transmitted from a first information processing apparatus to a second information processing apparatus, identifying a first value indicating a number of routers for the first packet to pass through before reaching the second information processing apparatus, receiving a second packet transmitted from the second information processing apparatus to the first information processing apparatus, setting a second value indicating an allowable number of the routers for the second packet to pass through, transmitting the second packet in which the second value is set, to a second router coupled to the first router, transmitting an acknowledgement packet for the second packet when the second packet reaches the first information processing apparatus, receiving the acknowledgement packet, and identifying the second router as a router that the first packet passed through, based on the acknowledgement packet.

### CROSS-REFERENCE TO RELATED APPLICATIONS

This application is based upon and claims the benefit of priority of the prior Japanese Patent Application No. 2015-244077, filed on Dec. 15, 2015, the entire contents of which are incorporated herein by reference.

### FIELD

The embodiment discussed herein is related to a method, an apparatus and a non-transitory computer-readable storage medium.

### BACKGROUND

A business operator that provides services to users (hereinafter simply referred to as a business operator), for example, builds a business system to provide various services to the users. The business system, for example, receives a processing request transmitted by a user via a terminal (hereinafter also referred to as a user terminal) and performs processing based on the contents of the processing request.

Processing requests transmitted as above reach the business system, for example, via multiple network devices (including repeaters such as routers and switches) depending on where the physical machine in which the business system is built is disposed, and on other factors. This makes it possible for the users to transmit processing requests to the business system even if the user terminals are physically away from the physical machine in which the business system is built.

Here, the network devices described above may include, for example, network devices that are not under the business operator's control (network devices under the control of other business operators such as communication carriers). For this reason, the business operator sometimes retrieves in advance the information on network devices disposed in the network between the business system and the user terminals. Specifically, the business operator, for example, retrieves the desired information by executing a command (such as traceroute or ping) to retrieve the information on the network devices disposed in the network between the business system and the user terminals.

Doing this makes it possible for the business operator, when a failure occurs in the network between the business system and a user terminal, to perform investigation into the cause of the failure and the like based on the information retrieved in advance. Japanese Laid-open Patent Publication No. 2003-008629 is listed as a related art document.

### SUMMARY

According to an aspect of the invention, a method using a first information processing apparatus, a second information processing apparatus, a plurality of routers that relay a packet between the first information processing apparatus and the second information processing apparatus, and an apparatus coupled to a first router included in the plurality of routers, the method includes relaying, by the first router, a first packet transmitted from the first information processing apparatus to the second information processing apparatus, identifying, by the apparatus, a first value indicating a number of routers for the first packet to pass through before reaching the second information processing apparatus, receiving, by the first router, a second packet transmitted from the second information processing apparatus to the first information processing apparatus, setting, by the apparatus, into the second packet, based on the first value, a second value indicating an allowable number of the routers for the second packet to pass through, transmitting, by the first router, the second packet in which the second value is set, to a second router that is included in the plurality of routers and coupled to the first router, transmitting, by the first information processing apparatus, an acknowledgement packet for the second packet when the second packet reaches the first information processing apparatus, receiving, by the first router, the acknowledgement packet, and identifying, by the apparatus, the second router as a router that the first packet passed through, based on the acknowledgement packet.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of an information processing system;

FIG. 2 is a diagram explaining a specific example where there are routers the information on which is not available;

FIG. 3 is a diagram explaining the specific example where there are the routers the information on which is not available;

FIG. 4 is a diagram illustrating a hardware configuration of a monitor apparatus;

FIG. 5 is a functional block diagram of the monitor apparatus;

FIG. 6 is a flowchart illustrating an outline of route search processing according to a first embodiment;

FIG. 7 is a flowchart illustrating the outline of the route search processing according to the first embodiment;

FIG. 8 is a diagram explaining the outline of the route search processing according to the first embodiment;

FIG. 9 is a diagram explaining the outline of the route search processing according to the first embodiment;

FIG. 10 is a diagram explaining the outline of the route search processing according to the first embodiment;

FIG. 11 is a diagram explaining the outline of the route search processing according to the first embodiment;

FIG. 12 is a diagram explaining the outline of the route search processing according to the first embodiment;

FIG. 13 is a flowchart explaining details of the route search processing according to the first embodiment;

FIG. 14 is a flowchart explaining details of the route search processing according to the first embodiment;

FIG. 15 is a flowchart explaining details of the route search processing according to the first embodiment;

FIG. 16 is a flowchart explaining details of the route search processing according to the first embodiment;

FIG. 17 is a flowchart explaining details of the route search processing according to the first embodiment;

FIG. 18 is a flowchart explaining details of the route search processing according to the first embodiment;

FIG. 19 is a flowchart explaining details of the route search processing according to the first embodiment;

FIG. 20 is a diagram explaining a specific example of route information;

FIG. 21 is a diagram explaining a specific example of hop count information;

FIG. 22 is a diagram explaining a specific example of temporary route information;

FIG. 23 is a diagram explaining a specific example of the temporary route information;

FIG. 24 is a diagram explaining a specific example of the temporary route information;

FIG. 25 is a diagram explaining a specific example of the route information;

FIG. 26 is a diagram explaining a specific example of the hop count information;

FIG. 27 is a diagram explaining a specific example of the temporary route information;

FIG. 28 is a diagram explaining a specific example of the route information; and

FIG. 29 is a diagram explaining a specific example of the hop count information.

### DESCRIPTION OF EMBODIMENT

Some of the network devices disclosed in the above related document operate under setting or condition not to transmit a response to a command to retrieve information on the network devices. In this case, the business operator is unable to retrieve the information on all the network devices disposed between the business system and the user terminals. As a result, in this case, when a failure occurs in the network between the business system and a user terminal, it is not possible for the business operator to perform investigation into the cause of the failure and the like.

[Configuration of Information Processing System]

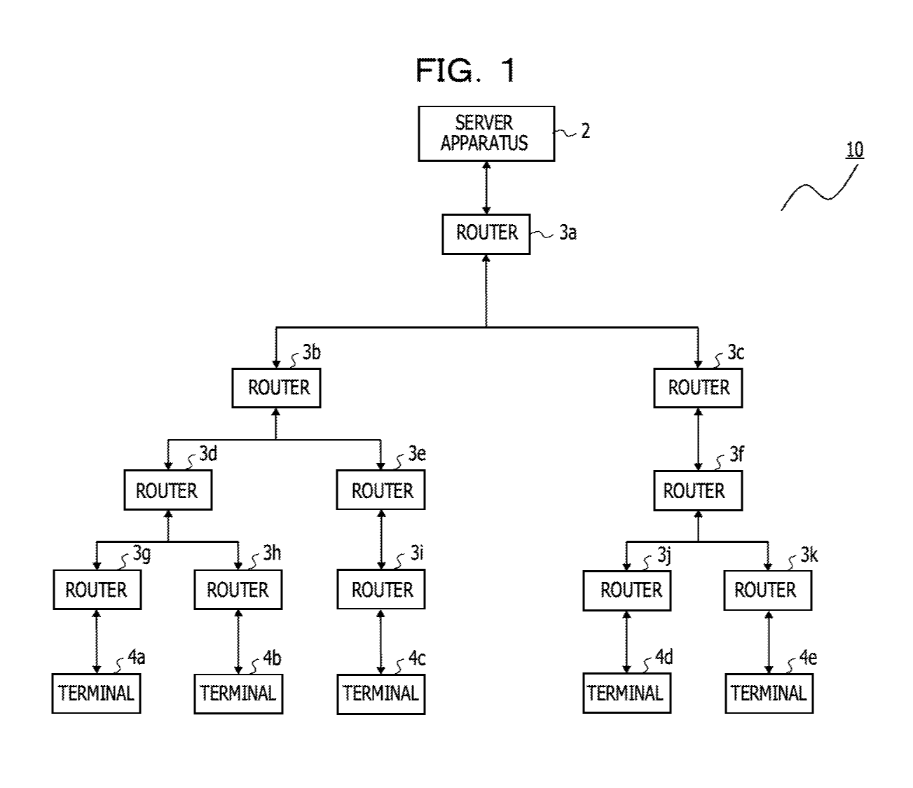

FIG. 1 is a diagram illustrating a configuration of an information processing system 10. The information processing system 10 illustrated in FIG. 1 includes a server apparatus 2; routers (repeaters) 3a, 3b, 3c, 3d, 3e, 3f, 3g, 3h, 3i, 3j, and 3k; and user terminals 4a, 4b, 4c, 4d, and 4e. Note that hereinafter the routers are also collectively and simply referred to as the routers 3, and the user terminals are also collectively and simply referred to as the user terminals 4.

The server apparatus 2 is a physical machine in which a business system is built to provide a service to users. The server apparatus 2 may include, for example, multiple physical machines.

The user terminals 4 are terminals that users use to transmit a packet for a processing request (hereinafter also simply referred to as a packet) to the business system (the server apparatus 2). The user terminals 4 are, for example, mobile phones, personal computers (PCs) and the like.

The routers 3 relay the packet transmitted from the user terminals 4, to the destination address of the packet (the server apparatus 2, for example). The routers 3 include, for example, a router that is not under the business operator's control. For this reason, for example, the business operator retrieves in advance information on the routers 3 disposed in the network between the server apparatus 2 and the user terminals 4. This makes it possible for the business operator, when a failure occurs in the network between the server apparatus 2 and a user terminal, to perform investigation into the cause of the failure and the like based on the information created in advance.

[Specific Example where there are Routers the Information on which is not Available]

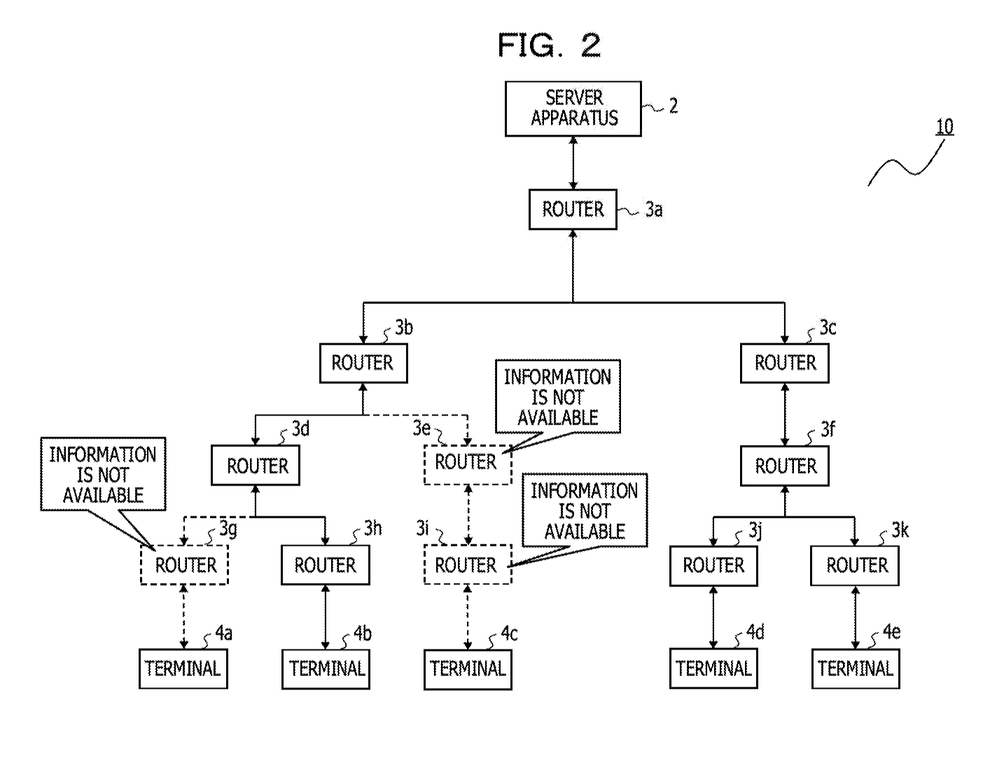

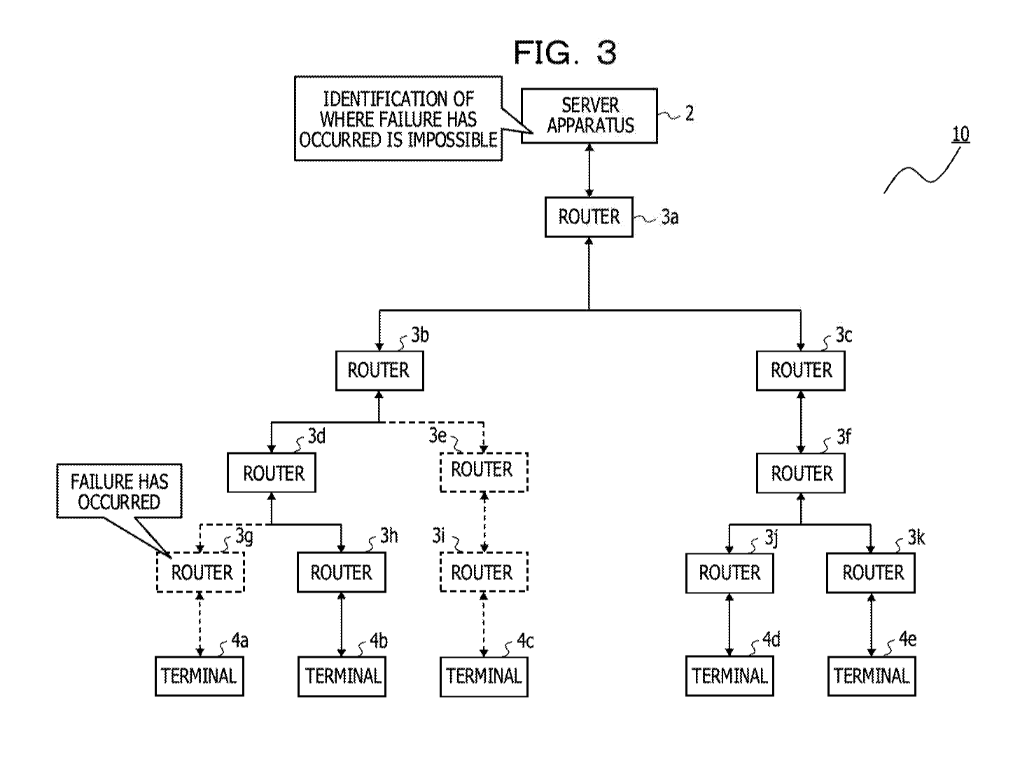

Next, descriptions are provided for a specific example where there are routers 3 the information on which is not available. FIGS. 2 and 3 are diagrams explaining the specific example where there are the routers 3 the information on which is not available.

The routers 3 explained with FIG. 1 include routers that are set not to respond to a command to retrieve each router's information. For this reason, in this case, the business operator is unable to retrieve information on all the routers 3 disposed between the server apparatus 2 and the user terminals 4.

Specifically, in the example illustrated in FIG. 2, in the case where the routers 3e, 3g, and 3i are the routers that do not respond, the business operator is unable to retrieve information on the network including the router 3g and the network including the routers 3e and 3i (the portions indicated by the broken lines in FIG. 2), for example. In other words, in this case, the business operator is unable to retrieve information such as the number of routers in the network between the router 3d and the user terminal 4a as well as the network between the router 3b and the user terminal 4c.

For this reason, for example, even when communications between the server apparatus 2 and the user terminals 4a are broken because a failure occurs in the router 3g as illustrated in FIG. 3, the business operator is unable to investigate the cause of the failure easily, such as identifying where the failure has occurred, based on information on the routers 3 created in advance.

To address this, a monitor apparatus 1 (hereinafter also referred to as a computer 1 or a route search apparatus 1) is disposed in this embodiment. The monitor apparatus 1 creates route information, which is information on the routers 3 that packets transmitted and received by the server apparatus 2 pass through. Then, when the router 3a the information on which is included in the route information receives a packet (hereinafter also referred to as a first packet) from the user terminal 4a, the monitor apparatus 1, for example, determines whether or not it is possible to identify all the routers 3 that the first packet passed through. As a result of the determination, in the case where it is not possible to identify all the routers 3 that the first packet passed through, the monitor apparatus 1 retrieves a response packet responding to the first packet and that the routers 3a retrieves from the server apparatus 2, and updates the number of routers 3 that the response packet is allowed to pass through, to the minimum number of routers that the response packet has to pass through to reach the user terminal 4a.

After that, the monitor apparatus 1 transmits the response packet toward the user terminal 4a through each of routers 3 selected in the ascending order of the hop count from the server apparatus 2. Then, the monitor apparatus 1 identifies the routers 3 existing between the server apparatus 2 and the user terminal 4a based on information on whether or not the response packet transmitted to the user terminal 4a reached the user terminal 4a.

In other words, by updating the number of routers 3 that the response packet is allowed to pass through to the number of routers 3 existing on the shortest route between the server apparatus 2 and the user terminal 4a, only the packet taking the shortest route is allowed to reach the user terminal 4a. As a result, in the case where the response packet reached the user terminal 4a, it is possible for the monitor apparatus 1 to identify the routers 3 that the response packet passed through as the routers 3 existing on the shortest route between the server apparatus 2 and the user terminal 4a.

In addition, by transmitting the response packet through each of the routers 3 selected in the ascending order of the hop count from the server apparatus 2, the monitor apparatus 1 identifies the routers 3 existing on the shortest route between the server apparatus 2 and the user terminal 4a in the order from the router 3 closest to the server apparatus 2. As a result, when the monitor apparatus 1 transmits the response packet again, it is possible to transmit the response packet through the routers 3 already identified. Thus, it is possible for the monitor apparatus 1 to reduce the number of response packets transmitted by the time that all the routers 3 existing on the shortest route between the server apparatus 2 and the user terminal 4a are identified.

[Hardware Configuration of Information Processing System 10]

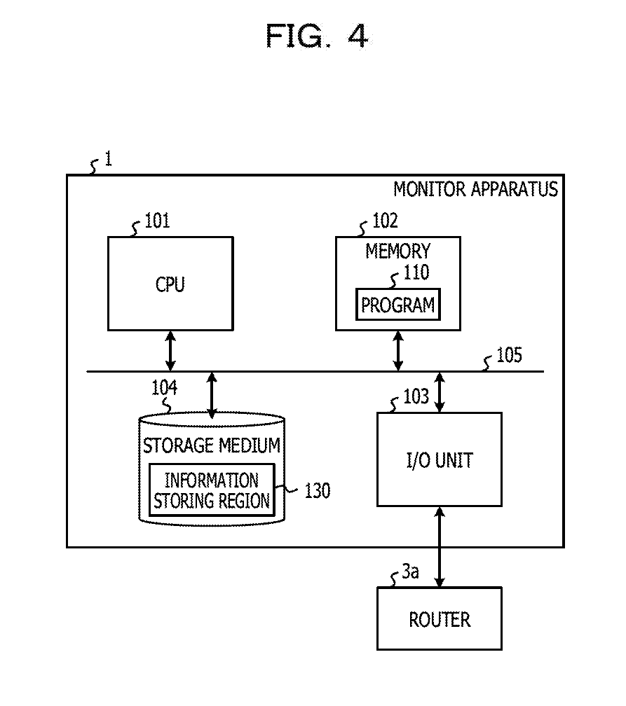

Next, descriptions are provided for a hardware configuration of the information processing system 10. FIG. 4 is a diagram illustrating a hardware configuration of the monitor apparatus 1.

The monitor apparatus 1 includes a CPU 101 as a processor, a memory 102, an outside interface (I/O unit) 103, and a storage medium 104. These units are coupled to each other through a bus 105.

The storage medium 104, for example, stores a program 110 in a program storing region (not illustrated) in the storage medium 104, for performing processing to identify the routers 3 existing between the server apparatus 2 and the user terminals 4 (hereinafter also referred to as route search processing) and other processing. In addition, the storage medium 104 includes an information storing region 130 (hereinafter also referred to as a storage unit 130) that stores information used for the route search processing, for example.

When executing the program 110, the CPU 101 loads the program 110 from the storage medium 104 into the memory 102 as illustrated in FIG. 4 and performs the route search processing in cooperation with the program 110. The outside interface 103 communicates with the router 3a and the like.

[Functions of Information Processing System]

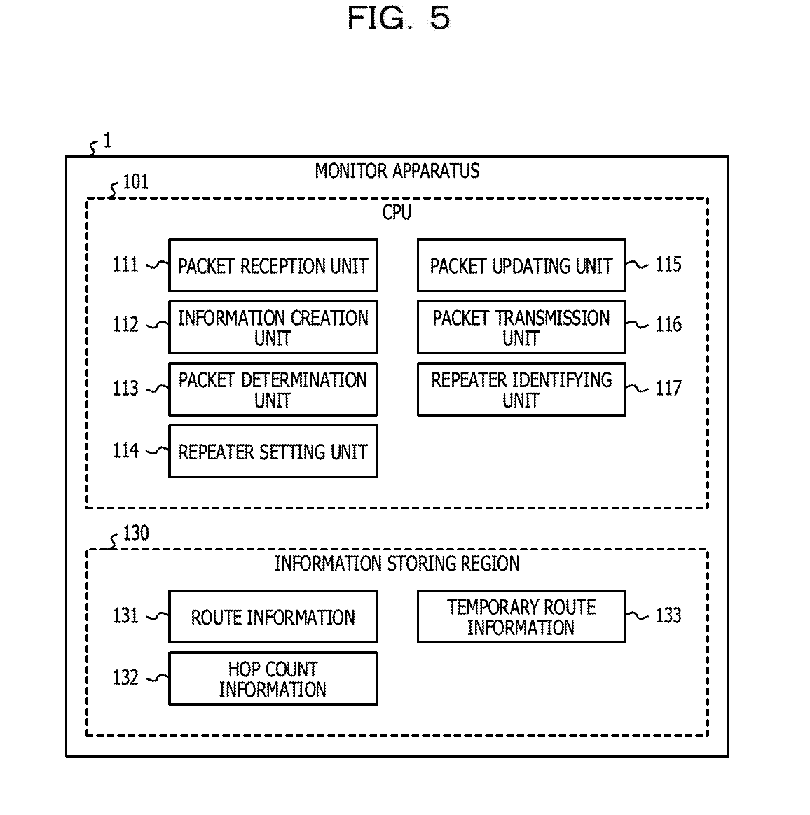

Next, descriptions are provided for functions of the information processing system 10. FIG. 5 illustrates a functional block diagram of the monitor apparatus 1.

By cooperating with the program 110, the CPU 101 of the monitor apparatus 1 functions, for example, as a packet reception unit 111, an information creation unit 112, a packet determination unit 113, and a repeater setting unit 114. In addition, by cooperating with the program 110, the CPU 101 of the monitor apparatus 1 functions, for example, as a packet updating unit 115, a packet transmission unit 116, and a repeater identifying unit 117. The information storing region 130 stores route information 131, hop count information 132, and temporary route information 133. Note that hereinafter descriptions are provided assuming the router 3a transmits and receives packets to and from the monitor apparatus 1.

The packet reception unit 111 receives a first packet that the router 3a receives from a user terminal 4. Specifically, every time the router 3a receives the first packet that a user terminal 4 transmits to the server apparatus 2, the router 3a transmits the first packet to the server apparatus 2 and the monitor apparatus 1, for example. Then, the packet reception unit 111 receives the first packet that the router 3a transmits. In addition, every time the router 3a receives a response packet responding to the first packet (a response packet that the server apparatus 2 transmits in response to the first packet), the router 3a, for example, transmits the response packet only to the monitor apparatus 1 instead of transmitting the response packet to the user terminal 4 that is the transmission destination of the response packet. Then, the packet reception unit 111 receives the response packet that the router 3a transmits.

The information creation unit 112 creates the route information 131, hop count information 132, and temporary route information 133. The information creation unit 112, then, stores the created route information 131, hop count information 132, and temporary route information 133 into the information storing region 130.

The route information 131 is information on the routers 3 to relay the first packet. Specifically, the route information 131 includes information on the routers 3 existing on the shortest route between the server apparatus 2 and each user terminal 4. The hop count information 132 is the information that sets the hop count from the server apparatus 2 to each router 3. The temporary route information 133 is information that, when only part of the routers 3 existing on the shortest route between the server apparatus 2 and a specific user terminal (the user terminal 4a, for example) included in the user terminals 4 is identified, temporarily sets information on the identified part of the routers 3. Specific examples for the route information 131, the hop count information 132, and the temporary route information 133 are described later.

The packet determination unit 113 refers to the route information 131 every time the packet reception unit 111 receives the first packet. The packet determination unit 113, then, determines whether or not it is possible to identify all the routers 3 (routes) that the received first packet passed through.

The repeater setting unit 114, for example, sets the router 3a such that every time the router 3a receives the first packet from a user terminal 4, the router 3a transmits the received first packet to the server apparatus 2 and also transmits the received first packet to the monitor apparatus 1.

In addition, in the case where all the routers 3 that the first packet passed through are not identified by the packet determination unit 113, the repeater setting unit 114 sets the router 3a such that the router 3a does not transmit the response packet transmitted by the server apparatus 2 to the transmission destination (the user terminal 4a, for example). Moreover, in this case, the repeater setting unit 114 sets the router 3a such that the router 3a transmits the response packet to the monitor apparatus 1.

Every time the packet reception unit 111 receives the response packet from the router 3a, the packet updating unit 115 updates the number of routers 3 that the received response packet is allowed to pass through to the minimum number of routers 3 that the response packet has to pass through to reach the user terminal of the transmission destination. Note that the packet updating unit 115 identifies the minimum number of routers 3 that the response packet has to pass through to reach the user terminal of the transmission destination, for example, from information included in an Internet Protocol (IP) header of the first packet.

The packet transmission unit 116, for example, transmits the response packet updated by the packet updating unit 115 to the user terminal 4 of the transmission destination.

The repeater identifying unit 117 instructs the packet transmission unit 116 to transmit the response packet to the user terminal 4 of the transmission destination one or more times through one or more routers 3 each selected in the ascending order of the hop count from the server apparatus 2. In addition, the repeater identifying unit 117 retrieves information on whether or not the response packet transmitted by the packet transmission unit 116 reached the user terminal 4 of the transmission destination.

Specifically, in the case where no router 3 has been identified by the repeater identifying unit 117, the repeater identifying unit 117 instructs the packet transmission unit 116 to sequentially transmit the response packet to the user terminal 4 of the transmission destination through each router 3 selected from the routers 3 having the smallest hop count from the server apparatus 2.

On the other hand, in the case where some routers 3 have already been identified by the repeater identifying unit 117, the repeater identifying unit 117 selects a router 3 having the largest hop count from the server apparatus 2 out of the routers 3 already identified by the repeater identifying unit 117. In this case, the repeater identifying unit 117, then, instructs the packet transmission unit 116 to transmit the response packet to the user terminal 4 of the transmission destination through each of routers 3 with the hop count of 1 from the selected router 3.

Then, the repeater identifying unit 117 identifies the routers 3 existing between the server apparatus 2 and the user terminal 4 of the transmission destination of the response packet based on information on whether or not the response packet transmitted by the packet transmission unit 116 reached the user terminal 4 of the transmission destination. Specifically, in the case where the response packet reached the user terminal 4 of the transmission destination, the repeater identifying unit 117 identifies the router 3 that the response packet was made to pass through as a router 3 existing between the server apparatus 2 and the user terminal 4 of the transmission destination.

After that, the repeater identifying unit 117 repeatedly performs the above process until the number of routers 3 identified as routers 3 existing between the server apparatus 2 and the user terminal 4 of the transmission destination becomes equal to the number of the routers 3 existing between the server apparatus 2 and the user terminal 4 of the transmission destination. In other words, the repeater identifying unit 117 repeatedly instructs the packet transmission unit 116 to transmit the response packet and identifies routers 3 existing between the server apparatus 2 and the user terminal 4 of the transmission destination.

Note that the repeater identifying unit 117 determines that the response packet reached the user terminal 4 of the transmission destination in the case where the packet reception unit 111 receives an acknowledgement (ACK) packet that the user terminal 4 of the transmission destination transmits on the arrival of the response packet. Hereinafter, the packet that the packet reception unit 111 receives in this case is also referred to as an ACK packet.

Meanwhile, in the case where the packet reception unit 111 receives from a router 3 (any of the routers 3) a packet indicating that there is a response packet that did not reach the user terminal 4 of the transmission destination after passing through the routers 3 of the number which the response packet was allowed to pass through, the repeater identifying unit 117 determines that the response packet did not reach the user terminal 4 of the transmission destination. In addition, in the case where the monitor apparatus 1 receives the first packet that the user terminal 4 of the transmission destination of the response packet retransmits, the repeater identifying unit 117 determines that the response packet did not reach the user terminal 4 of the transmission destination. Moreover, in the case where the packet reception unit 111 does not receive a packet related to the first packet and the response packet by the time a predetermined time-out period has passed after the packet transmission unit 116 transmits the response packet, the repeater identifying unit 117 determines that the response packet did not reach the user terminal 4 of the transmission destination.

Meanwhile, the repeater setting unit 114 sets the router 3a such that in the case where the router 3a receives a negative acknowledgment (NACK) packet from the user terminal 4 of the transmission destination of the response packet, the router 3a transmits the received NACK packet to the monitor apparatus 1 instead of transmitting the received NACK packet to the server apparatus 2. On the other hand, the repeater setting unit 114 sets the router 3a such that in the case where the router 3a receives the ACK packet from the user terminal 4 of the transmission destination of the response packet, the router 3a transmits the received ACK packet to the server apparatus 2 and the monitor apparatus 1. Note that the repeater setting unit 114 may perform setting related to the case where the router 3a receives the ACK packet and the NACK packet, for example, when the router 3a receives the first packet from a user terminal 4.

### First Embodiment

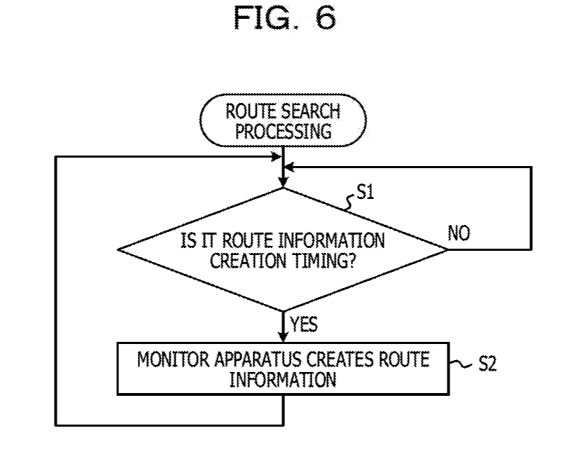

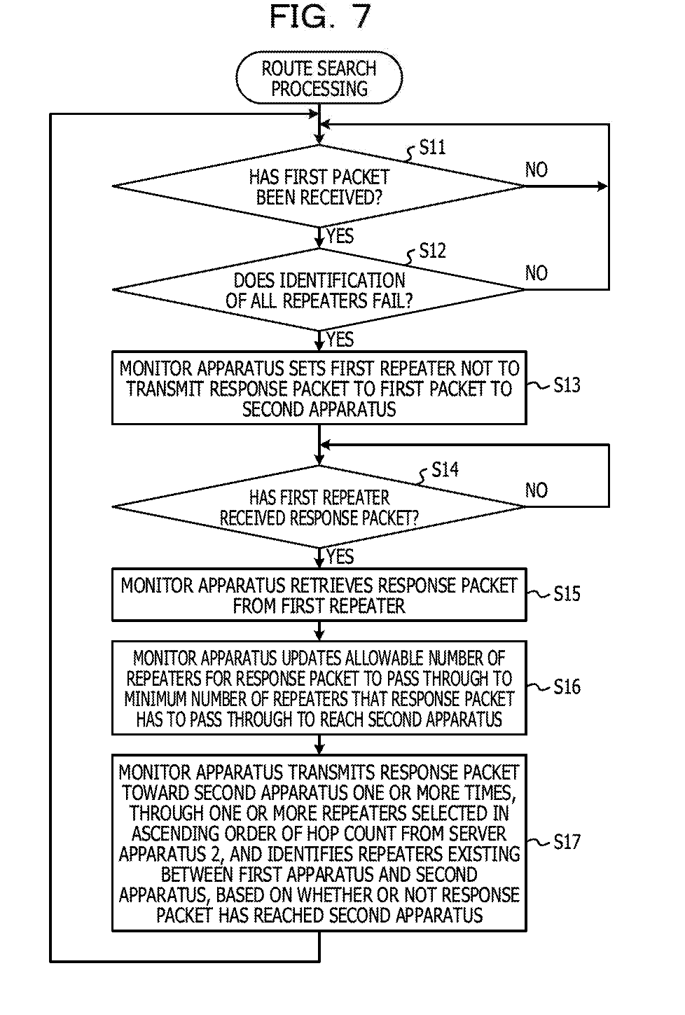

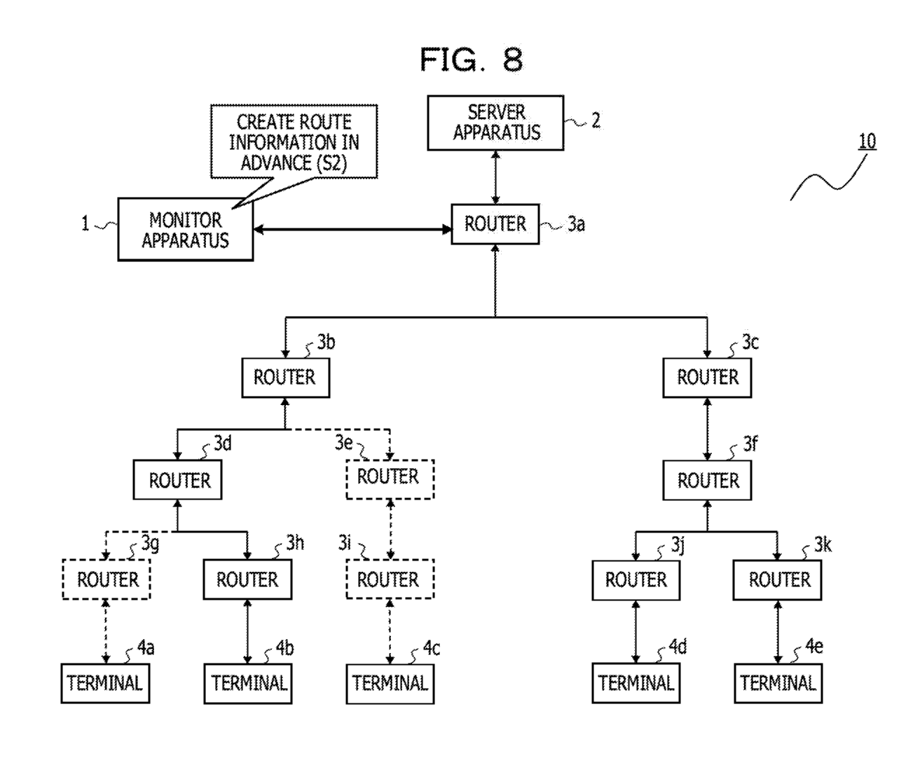

Next, a first embodiment is described. FIGS. 6 and 7 are flowcharts illustrating an outline of the route search processing according to the first embodiment. FIGS. 8 to 12 are diagrams explaining the outline of the route search processing according to the first embodiment. Referring to FIGS. 8 to 12, the outline of the route search processing illustrated in FIGS. 6 and 7 is described. Note that hereinafter descriptions are provided assuming the hop count from the monitor apparatus 1 to the router 3a is “1” as illustrated in FIG. 8 and others.

As illustrated in FIG. 6, the monitor apparatus 1 waits until the timing of creating the route information 131 (hereinafter also referred to as a route information creation timing) comes (No at S1). The route information creation timing may be, for example, a timing the business operator starts operation of the business system. After that, when the route information creation timing comes (YES at S1), the monitor apparatus 1 creates the route information 131 as illustrated in FIG. 8 (S2).

Specifically, the monitor apparatus 1 retrieves information on the routers the information on which is available among the routers 3 existing between the server apparatus 2 and each user terminal 4. Then, the monitor apparatus 1 creates the route information 131 from the retrieved information. Thus, for example, in the case where a failure occurs at a router 3 the information on which is included in the route information 131, it is possible for the business operator to quickly identify where the failure has occurred.

Note that the business operator may create the route information 131 by inputting information on each router 3 into the monitor apparatus 1. A specific example of the route information 131 is described later.

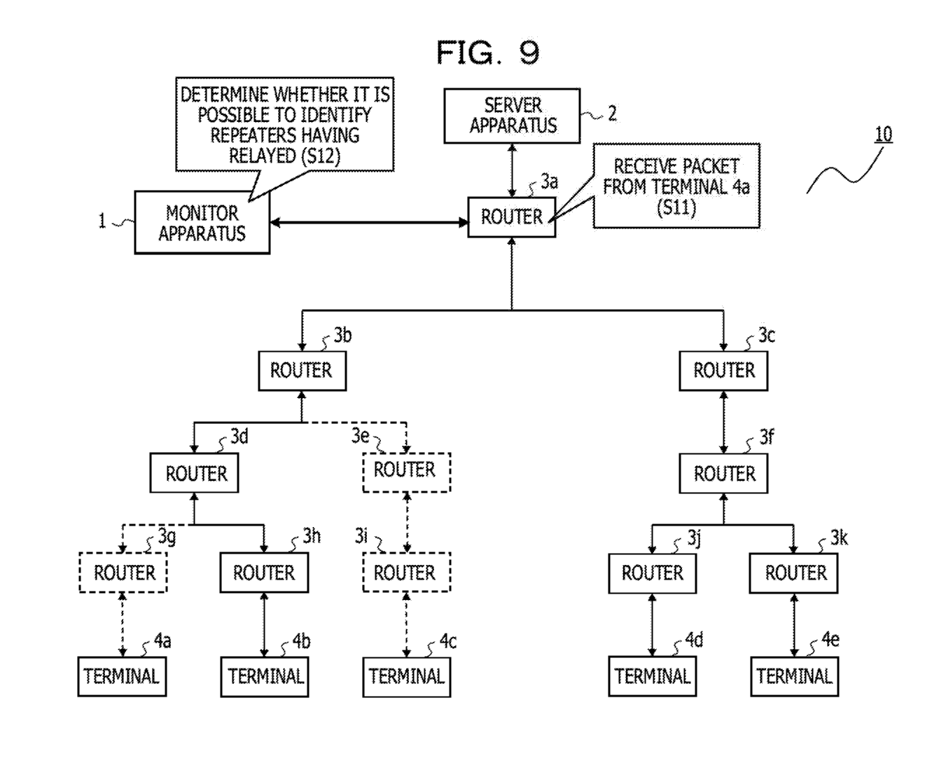

Then, the monitor apparatus 1 waits as described in FIG. 7 until the router 3a receives the first packet (NO at S11). After that, in the case where the router 3a receives the first packet (YES at S11), the monitor apparatus 1, as illustrated in FIG. 9, determines whether or not it is possible to identify all the routers 3 that the first packet passed through before reaching the router 3a based on the route information 131 (S12). In other words, the monitor apparatus 1 determines whether or not it is possible to identify the route that the first packet received by the router 3a passed through based on information included in the route information 131.

As a result of the determination, in the case where all the routers 3 that the first packet passed through before reaching the router 3a are identified (NO at S12), the monitor apparatus 1 waits until the router 3a receives the next first packet (NO at S11). In other words, in this case, the monitor apparatus 1 determines that it is possible to identify the route the first packet received by the router 3a passed through, based on the information included in the route information 131. Accordingly, the monitor apparatus 1 determines that the route between the server apparatus 2 and the user terminal 4 of the transmission source of the first packet received by the router 3a does not has to be identified in this case and does not perform S13 and the subsequent processes.

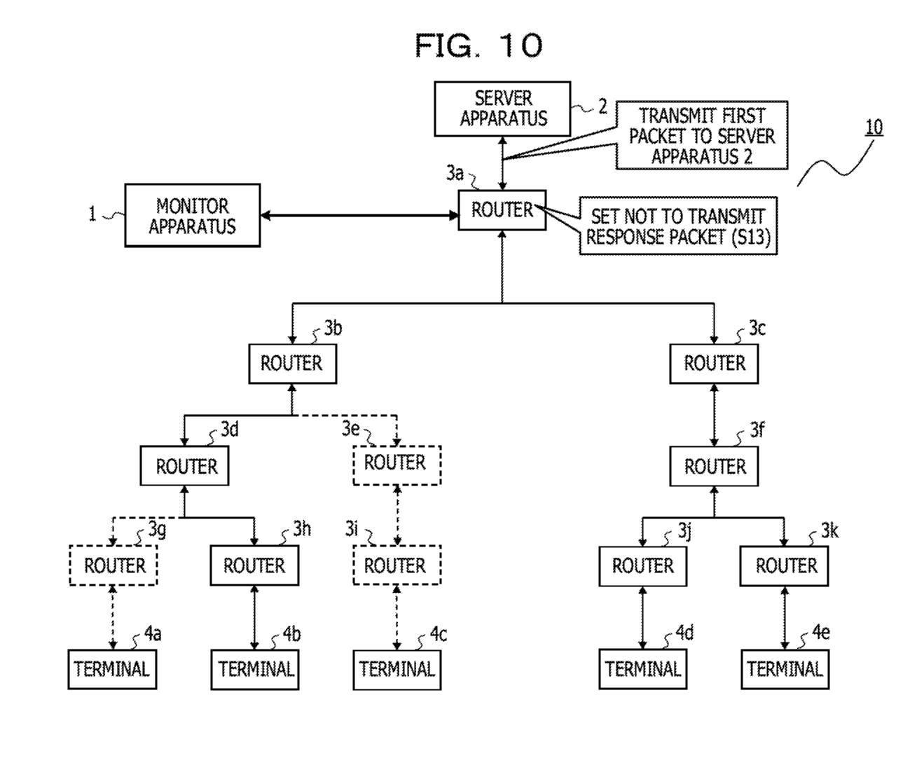

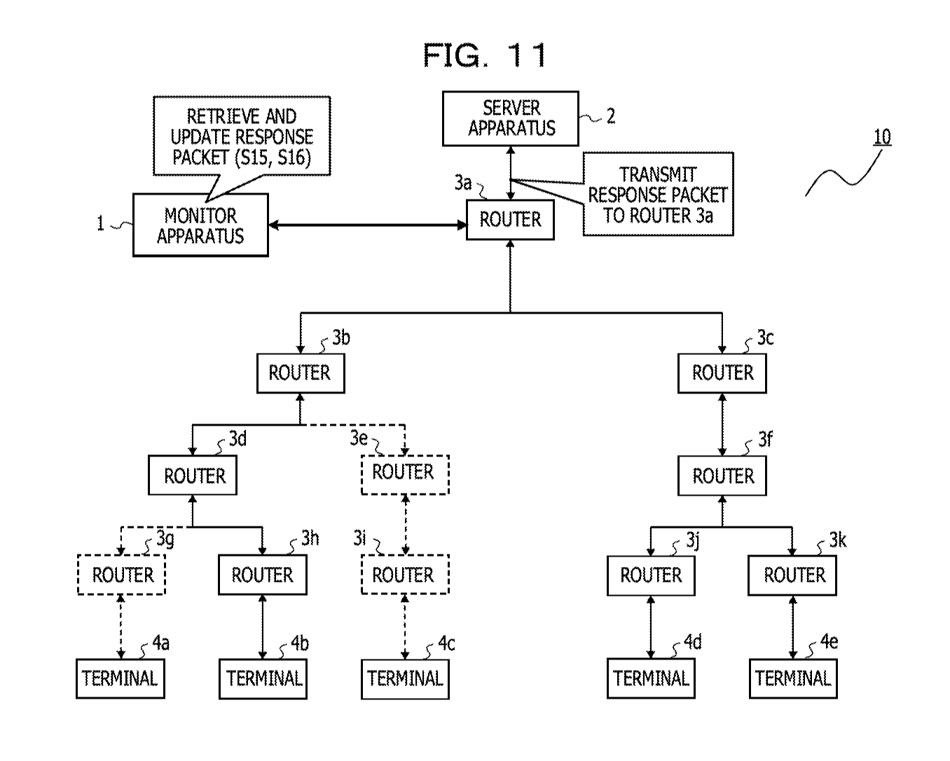

On the other hand, in the case where all the routers 3 that the first packet passed through before reaching the router 3a are not identified (YES at S12), the monitor apparatus 1, as illustrated in FIG. 10, sets the router 3a such that the router 3a does not transmit the response packet responding to the first packet to the user terminal 4 of the transmission destination (S13). After that, the monitor apparatus 1 waits until the router 3a receives the response packet from the server apparatus 2 (NO at S14). Then, in the case where the router 3a receives the response packet from the server apparatus 2 (YES at S14), the monitor apparatus 1, as illustrated in FIG. 11, retrieves the response packet from the router 3a (S15).

In other words, in this case, in order to identify the route between the server apparatus 2 and the user terminal 4 of the transmission source of the response packet received by the router 3a, the monitor apparatus 1 retrieves the response packet from the router 3a while prohibiting the router 3a from transmitting the response packet to the user terminal 4 of the transmission destination.

After that, as illustrated in FIG. 11, the monitor apparatus 1 updates the allowable number of repeaters for the response packet to pass through, to the minimum number of routers 3 that the response packet has to pass through to reach the user terminal 4 of the transmission destination (S16). This enables the monitor apparatus 1 to cause the response packet to reach the user terminal 4 of the transmission destination only when the response packet is transmitted to the user terminal 4 of the transmission destination through the shortest route (the minimum number of routers 3).

Note that when the router 3a receives the first packet, the monitor apparatus 1 may identify the minimum number of routers 3 that the response packet has to pass through to reach the user terminal 4 of the transmission destination, based on information set in the Time-to-live (TTL) included in the IP header of the first packet, for example.

Specifically, the monitor apparatus 1 identifies the number of routers 3 that the first packet passed through before reaching the router 3a, for example, by calculating the difference between the initial value of a value set in TTL and a value set in TTL of the first packet. Then, the monitor apparatus 1 identifies the minimum number of routers 3 that the response packet has to pass through to reach the user terminal 4 of the transmission destination, from the number of routers 3 that the first packet passed through before reaching the router 3a.

Specifically, in the case where the value set in TTL of the first packet retrieved from the router 3a is “125”, the monitor apparatus 1 presumes that the operating system (OS) of the user terminal 4 that transmitted the first packet is Windows (registered trademark: the OS that sets an initial value of TTL of a packet to “128”). Then, the monitor apparatus 1 identifies “3” which is the difference between “128”, which is the estimated initial value of TTL of the packet, and “125”, which is set in TTL of the first packet, as the number of routers 3 that the first packet passed through before reaching the router 3a. From this result, the monitor apparatus 1 identifies “3” in this case, as the minimum number of routers 3 that the response packet has to pass through to reach the user terminal 4 of the transmission destination.

Here, in the case where “3” is set for TTL of the response packet, TTL of the response packet becomes “0” at a router 3 just before the user terminal 4 of the transmission destination. As a result, in this case, the response packet does not reach the user terminal 4 of the transmission destination. Accordingly, in the case where “3” is identified as the minimum number of routers 3 that the response packet has to pass through to reach the user terminal 4 of the transmission destination, the monitor apparatus 1 sets TTL of the response packet to “4” (in other words, the hop count from the monitor apparatus 1 to the user terminal 4 of the transmission destination).

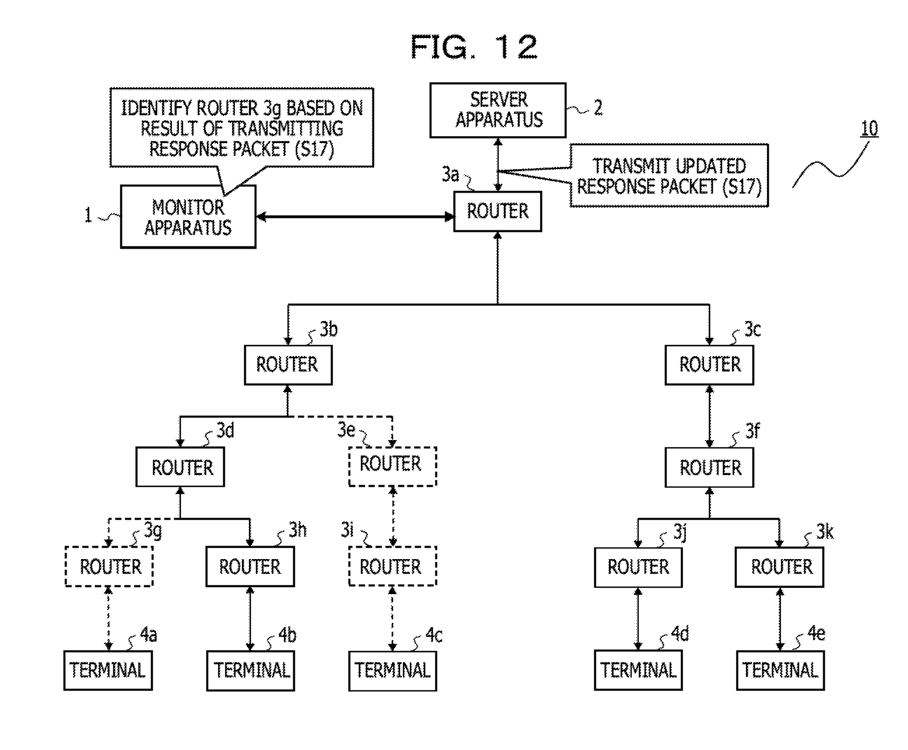

After that, the monitor apparatus 1 transmits the response packet toward the user terminal 4 one or more times, as illustrated in FIG. 12, through one or more routers 3a selected in the ascending order of the hop count from the server apparatus 2. Then, the monitor apparatus 1 identifies the routers 3 existing between the server apparatus 2 and the user terminal 4 based on information on whether or not the response packet reached the user terminal 4 (S17).

Specifically, the response packet reaches the user terminal 4 of the transmission destination only when the response packet is transmitted to the user terminal 4 of the transmission destination through the shortest route (the minimum number of routers 3) between the server apparatus 2 and the user terminal 4 of the transmission destination. For this reason, in the case where the response packet reached the user terminal 4 of the transmission destination, it is possible for the monitor apparatus 1 to determines that the routers 3 that the response packet was made to pass through are the routers 3 existing between the server apparatus 2 and the user terminal 4 of the transmission destination.

In addition, by transmitting the response packet through each of the routers 3 selected in the ascending order of the hop count from the server apparatus 2, it is possible for the monitor apparatus 1 to identify the routers 3 existing on the shortest route between the server apparatus 2 and the user terminal 4 of the transmission destination in the order from the router 3 closest to the server apparatus 2. As a result, when the monitor apparatus 1 transmits the response packet again, it is possible to transmit the response packet through the routers 3 already identified. Thus, it is possible for the monitor apparatus 1 to reduce the number of response packets that have to be transmitted by the time that all the routers 3 existing between the server apparatus 2 and the user terminal 4 are identified.

Thus, the monitor apparatus 1 creates the route information 131, which is information on the routers 3 that packets transmitted and received by the server apparatus 2 pass through. Then, in the case where the router 3a the information on which is included in the route information 131 receives the first packet transmitted from a user terminal 4 toward the server apparatus 2, the monitor apparatus 1 determines whether or not it is possible to identify all the routers 3 that the first packet passed through based on the route information 131. As a result of the determination, in the case where it is not possible to identify all the routers 3 that the first packet passed through based on the route information 131, the monitor apparatus 1 sets the router 3a such that the router 3a does not transmit the response packet responding to the first packet to the user terminal 4 of the transmission destination, while transmitting the first packet to the server apparatus 2.

After that, every time the router 3a receives the response packet, the monitor apparatus 1 retrieves the response packet from the router 3a and updates the number of routers 3 that the retrieved response packet is allowed to pass through to the minimum number of routers 3 that the response packet has to pass through to reach the user terminal 4 of the transmission destination. In addition, the monitor apparatus 1 transmits the updated response packet toward the user terminal 4 of the transmission destination one or more times through one or more routers 3a selected in the ascending order of the hop count from the server apparatus 2. Then, the monitor apparatus 1 identifies the routers 3 existing between the server apparatus 2 and the user terminal 4 of the transmission destination based on information on whether or not the transmitted response packet reached the user terminal 4 of the transmission destination. This makes it possible for the monitor apparatus 1 to identify the route including routers 3 the information on which is not available.

[Details of First Embodiment]

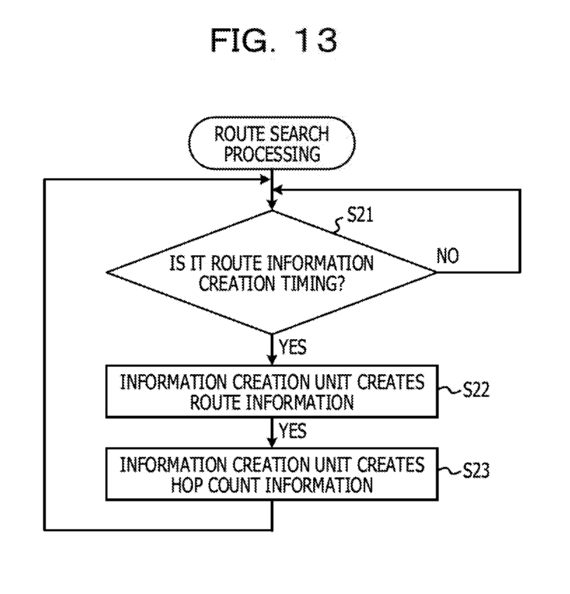

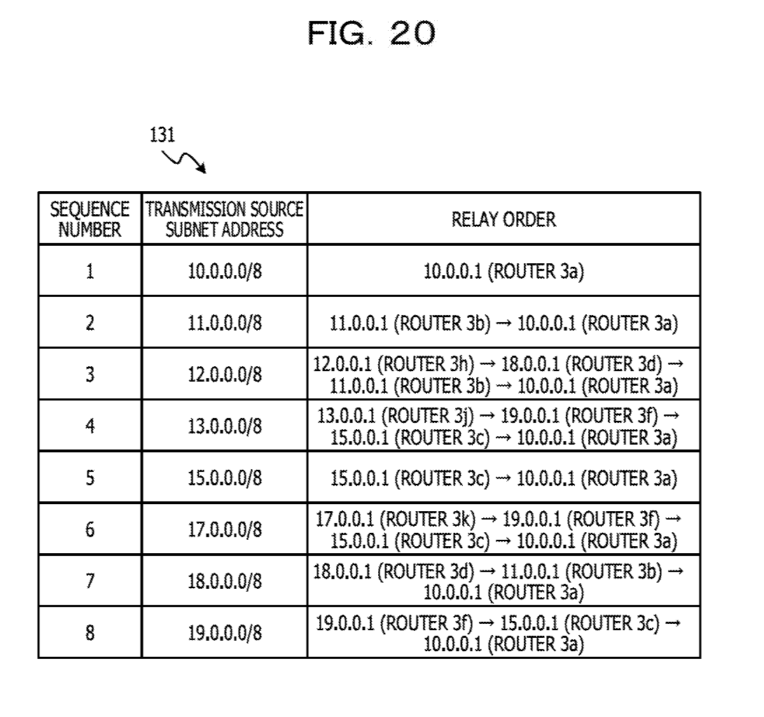

Next, details of a first embodiment are described. FIGS. 13 to 19 are flowcharts explaining details of the route search processing according to the first embodiment. In addition, FIGS. 20 to 29 are diagrams explaining the details of the route search processing according to the first embodiment. Referring to FIGS. 20 to 29, the details of the route search processing illustrated in FIGS. 13 to 19 are described. Note that hereinafter descriptions are provided for the route search processing in the case where the first packet is transmitted from the user terminal 4a toward the server apparatus 2 in the information processing system 10 illustrated in FIG. 8 and others.

As illustrated in FIG. 13, the information creation unit 112 of the monitor apparatus 1 waits until the route information creation timing comes (NO at S21). Then, when the route information creation timing comes (YES at S21), the monitor apparatus 1 creates the route information 131 (S22). Hereinafter, descriptions are provided for a specific example of the route information 131.

[Details of Route Information]

FIGS. 20, 25, and 28 are diagrams explaining a specific example of the route information 131. The route information 131 illustrated in FIGS. 20, 25, and 28 includes as items a “sequence number” to distinguish the information pieces included in the route information 131 and a “transmission source subnet address” indicating subnet addresses of user terminals 4. The route information 131 illustrated in FIGS. 20, 25, and 28 also includes as an item a “relay order”, which is information indicating a route (an order of routers 3) that the first packet transmitted by the user terminals 4 corresponding to the subnet addresses set in the “transmission source subnet address” passes through before reaching the server apparatus 2.

Specifically, in the route information 131 illustrated in FIG. 20, for the information with the “sequence number” of “1”, “10.0.0.0/8” is set as the “transmission source subnet address”, and “10.0.0.1 (router 3a)” is set as the “relay order”. In other words, the information with the “sequence number” of “1” in the route information 131 illustrated in FIG. 20 indicates that the first packet transmitted from the user terminal 4 with the subnet address of “10.0.0.0/8” to the server apparatus 2 passes through only the router 3 with the IP address of “10.0.0.1”.

In addition, in the route information 131 illustrated in FIG. 20, for the information with the “sequence number” of “7”, “18.0.0.0/8” is set as the “transmission source subnet address”, and “18.0.0.1 (router 3d) 11.0.0.1 (router 3b) 10.0.0.1 (router 3a)” is set as the “relay order”. In other words, the information with the “sequence number” of “7” in the route information 131 illustrated in FIG. 20 indicates that the first packet transmitted from the user terminal 4 with the subnet address of “18.0.0.0/8” to the server apparatus 2 passes through the router 3d, the router 3b, and the router 3a in this order. Descriptions for the other information in FIG. 20 are omitted.

Returning to FIG. 13, the information creation unit 112 creates the hop count information 132 (S23). Hereinafter, a specific example of the hop count information 132 is described.

[Details of Hop Count Information]

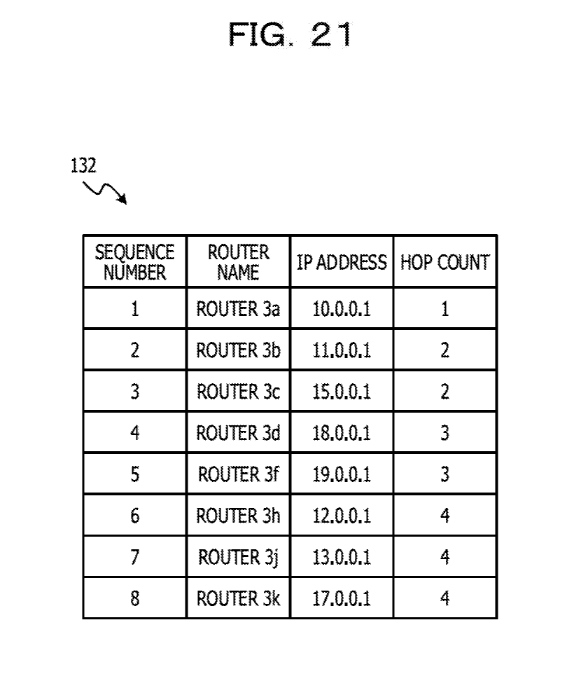

FIGS. 21, 26, and 29 are diagrams explaining a specific example of the hop count information 132. The hop count information 132 illustrated in FIGS. 21, 26, and 29 includes as items an “sequence number” to distinguish the information pieces included in the hop count information 132, a “router name” to distinguish routers 3, and an “IP address” indicating the IP address of the router set in the “router name”. The hop count information 132 illustrated in FIGS. 21, 26, and 29 also includes as an item “the hop count” indicating the number of hops from the server apparatus 2 to the router 3 set in the “router name”.

Specifically, in the hop count information 132 illustrated in FIG. 21, for the information with the “sequence number” of “1”, “router 3a” is set as the “router name”, “10.0.0.1” is set as the “IP address”, and “1” is set as “the hop count”. In addition, in the hop count information 132 illustrated in FIG. 21, for the information with the “sequence number” of “5”, “router 3f” is set as the “router name”, “19.0.0.1” is set as the “IP address”, and “3” is set as “the hop count”.

In other words, the information with the “sequence number” of “5” in the hop count information 132 illustrated in FIG. 21 indicates as illustrated in FIG. 8 and others that the response packet transmitted by the server apparatus 2 passes through the three routers (the router 3a, the router 3c, and the router 3f) by the time the response packet reaches the router 3f.

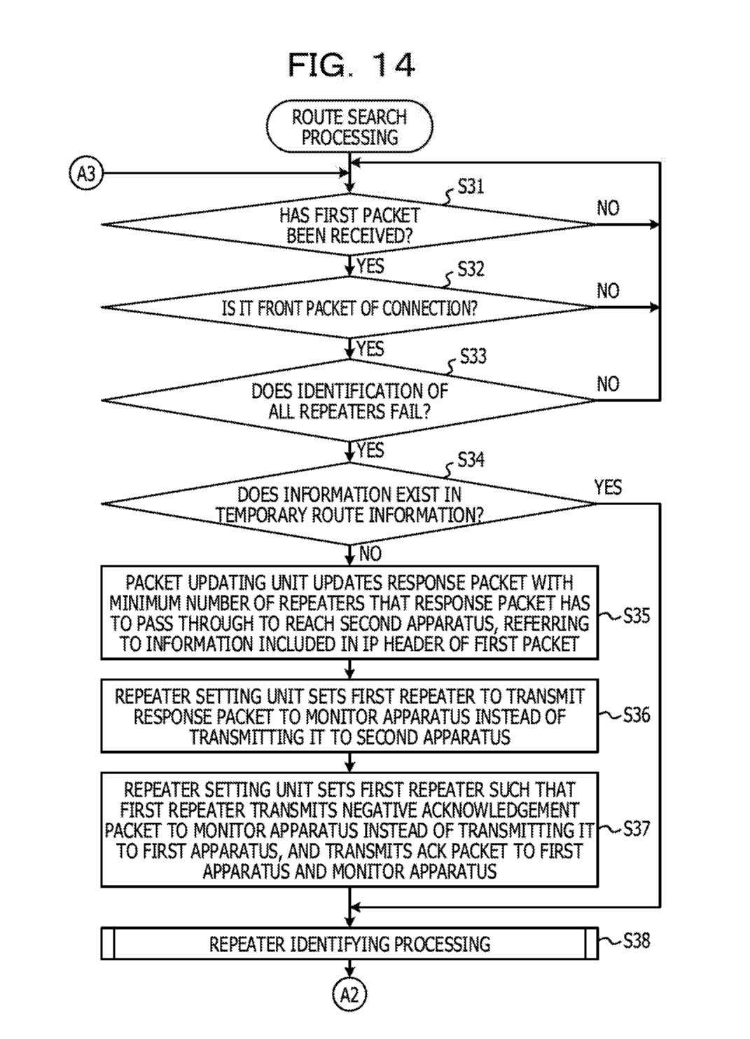

Returning to FIG. 14, the packet reception unit 111 of the monitor apparatus 1 waits until the router 3a receives the first packet (NO at S31). In the case where the route 3a receives the first packet (YES at S31), the packet reception unit 111 determines whether or not the first packet received in the process of S31 is the front packet of the connection (S32). As a result of the determination, in the case where it is determined that the first packet is the front packet of the connection (Yes at S32), the packet determination unit 113 of the monitor apparatus 1 determines whether or not it is possible to identify all the routers 3 that the first packet passed through before reaching the router 3a (S33).

Specifically, the packet determination unit 113 determines whether or not the route information 131 includes information on the route from the user terminal 4a of the transmission source of the first packet to the server apparatus 2. Then, in the case where the information on the route from the user terminal 4a of the transmission source of the first packet to the server apparatus 2 is included in the route information 131, the packet determination unit 113 determines that it is possible to identify all the routers 3 that the first packet passed through before reaching the router 3a.

Meanwhile, in the case where the first packet received in the process of S31 is not the front packet of the connection (NO at S32), the packet reception unit 111 waits until the packet reception unit 111 receives the next first packet (NO at S31).

Specifically, in the case where the packet reception unit 111 receives a packet different from the front packet of the connection in the process of S31, it is possible for the packet reception unit 111 to determines that information on the route of the packet already exists in the route information 131 or that the route search processing to identify the route of the packet has already been performed. For this reason, the monitor apparatus 1 does not perform S33 and the subsequent processes in this case. This makes it possible for the monitor apparatus 1 to perform the route search processing efficiently.

In addition, in the case where all the routers 3 that the first packet passed through before reaching the router 3a were identified (NO at S33), the packet reception unit 111 also waits until the packet reception unit 111 receives the next first packet (NO at S31).

On the other hand, in the case where it is not possible to identify all the routers 3 that the first packet passed through before reaching the router 3a (YES at S33), the packet updating unit 115 of the monitor apparatus 1 determines whether or not information exists in the temporary route information 133 (34). Hereinafter, a specific example of the temporary route information 133 is described.

[Details of Temporary Route Information]

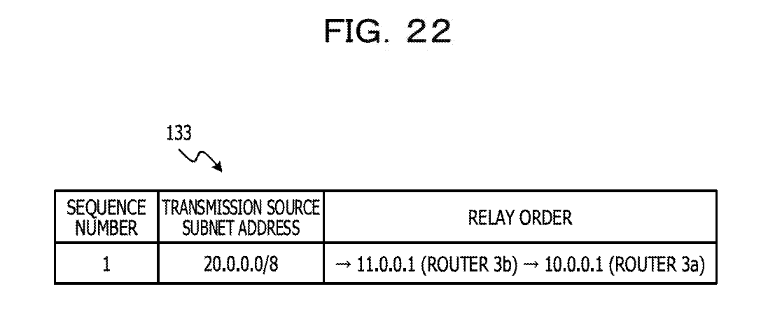

FIGS. 22, 23, 24, and 27 are diagrams explaining specific examples of the temporary route information 133. The temporary route information 133 illustrated in FIGS. 22, 23, 24, and 27 includes the same items as in the route information 131 explained with FIG. 20.

Specifically, in the temporary route information 133 illustrated in FIG. 22, for the information with the “sequence number” of “1”, “20.0.0.0/8” is set as the “transmission source subnet address”, and “→11.0.0.1 (router 3b)→10.0.0.1 (router 3a)” is set as the “relay order”. In other words, the information with the “sequence number” of “1” in the temporary route information 133 illustrated in FIG. 22 indicates that only the router 3b and the router 3a are identified among the routers 3 existing between the server apparatus 2 and the user terminal 4 with the subnet address of “20.0.0.0/8”.

Returning to FIG. 14, in the case where information does not exist in the temporary route information 133 (NO at S34), the packet updating unit 115 identifies the minimum number of routers 3 that the response packet has to pass through to reach the user terminal 4a of the transmission source of the first packet, from information included in the IP header of the first packet (S35).

In other words, in the case where information does not exist in the temporary route information 133, the temporary route information 133 indicates that a route in between that has been identified does not exist. For this reason, in this case, in order to start identifying the route of the first packet received by the packet reception unit 111, the packet updating unit 115 retrieves information to be used to update TTL included in the IP header of the response packet. Hereinafter descriptions are provided assuming the minimum number of routers 3 that the updated response packet has to pass through to reach the user terminal 4a is “4” (the routers 3a, 3b, 3d, and 3g) as illustrated in FIG. 8 and others. In other words, hereinafter it is assumed that the hop count from the monitor apparatus 1 to the user terminal 4a is “5” as illustrated in FIG. 8 and others.

After that, the repeater setting unit 114 sets the router 3a such that the router 3a transmits the response packet responding to the first packet to the monitor apparatus 1, instead of transmitting the response packet to the user terminal 4a (S36). This makes it possible for the packet updating unit 115 to update TTL of the response packet. This also makes it possible for the repeater setting unit 114 to keep the response packet the TTL of which is not updated by the packet updating unit 115 from being transmitted to the user terminal 4a.

Then, the repeater setting unit 114 sets the router 3a such that the router 3a transmits NACK packets transmitted from the user terminal 4a, to the monitor apparatus 1 instead of transmitting the NACK packets to the server apparatus 2. In addition, the repeater setting unit 114 sets the router 3a such that the router 3a transmits ACK packets transmitted from the user terminal 4a to both the server apparatus 2 and the monitor apparatus 1 (S37). This makes it possible for the repeater setting unit 114 to keep packets that do not have to be transmitted to the server apparatus 2 from being transmitted to the server apparatus 2. This in turn makes it possible for the repeater setting unit 114 to keep the route search processing from affecting other processing performed by the server apparatus 2.

On the other hand, in the case where information exists in the temporary route information 133 in the process of S34 (YES at S34), the monitor apparatus 1 does not perform the processes from S35 to S37. Specifically, the case where the first packet received by the packet reception unit 111 is the front packet of the connection (YES at S31 and YES at S32) and where information exists in the temporary route information 133 (YES at S34) is the case where a connection terminated while the route search processing is being performed resumes. For this reason, in this case, the monitor apparatus 1 does not perform again preparation processes (S35 to S37) to update the response packet.

Then, after the process of S37, or in the case where information exists in the temporary route information 133 (YES at S34), the repeater identifying unit 117 of the monitor apparatus 1 performs processing to identify the routers 3 existing on the shortest route between the server apparatus 2 and the user terminal 4a (hereinafter also referred to as repeater identifying processing) (S38). Hereinafter, the repeater identifying processing is described.

[Repeater Identifying Processing]

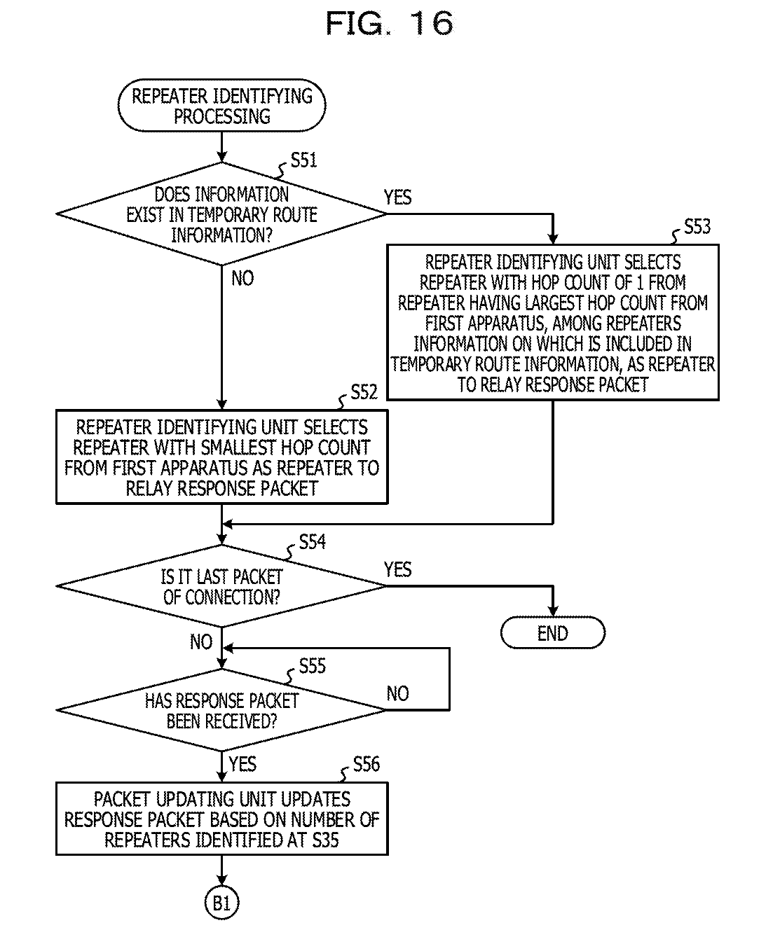

As illustrated in FIG. 16, the repeater identifying unit 117 determines whether or not information exists in the temporary route information 133, in other words, whether or not there is a router already identified as a router 3 existing between the server apparatus 2 and the user terminal 4a (S51). Then, in the case where information does not exists in the temporary route information 133 (NO at S51), the repeater identifying unit 117 selects a router 3 having the smallest hop count from the server apparatus 2 as a router 3 to relay the response packet (S52).

In other words, in the case where information does not exist in the temporary route information 133, the repeater identifying unit 117 has to start from the beginning to identify the routers 3 existing between the server apparatus 2 and the user terminal 4a. For this reason, in the example illustrated in FIG. 8 and others, the repeater identifying unit 117 selects the router 3a which has the smallest hop count from the server apparatus 2 among the routers 3 as a router to relay the response packet.

On the other hand, in the case where information exists in the temporary route information 133 (YES at S51), the repeater identifying unit 117 selects a router having the largest hop count from the server apparatus 2 out of the routers 3 the information on which is included in the temporary route information 133. Then, in this case, the repeater identifying unit 117 selects a router with a hop count of 1 from the selected router as a router to relay the response packet (S53). In other words, in this case, the repeater identifying unit 117 starts identifying the routers 3 existing between the server apparatus 2 and the user terminal 4a from the next router to the routers 3 the information on which is included in the temporary route information 133.

Specifically, in the “relay order” of the information with the “sequence number” of “1” in the temporary route information 133 illustrated in FIG. 22, “→11.0.0.1 (router 3b)→10.0.0.1 (router 3a)” is set. Accordingly, in the example illustrated in FIG. 22, the repeater identifying unit 117 determines that the router 3a and the router 3b have already been identified as routers 3 existing between the server apparatus 2 and the user terminal 4a. Meanwhile, as illustrated in the hop count information 132 in FIG. 21, the hop count of the router 3a is “1”, and the hop count of the router 3b is “2”. Accordingly, the repeater identifying unit 117 selects the router 3b as the router having the largest hop count from the server apparatus 2. After that, for example, referring to the information with the “sequence number” of “3” in the route information 131 illustrated in FIG. 20, the repeater identifying unit 117 selects the router 3d, which is a router with a hop count of “1” from the router 3b (a router with a hop count of “3” from the server apparatus 2 is “3”), as a router to relay the response packet.

After that, the repeater identifying unit 117 determines whether or not the first packet received by the packet reception unit 111 in the process of S31 is the last packet of the connection (S54). Specifically, in the case where the received first packet is the last packet of the connection, it is not possible for the monitor apparatus 1 to continue to perform the route search processing because the connection between the server apparatus 2 and the user terminal 4a will be terminated. Accordingly, in this case, the repeater identifying unit 117 terminates the repeater identifying processing.

On the other hand, in the case where the first packet received by the packet reception unit 111 in the process of S31 is not the last packet of the connection (NO at S54), the packet reception unit 111 waits until the packet reception unit 111 receives the response packet transmitted by the server apparatus 2 (the response packet responding to the first packet) (NO at S55). Then, in the case the packet reception unit 111 receives the response packet (YES at S55), the packet updating unit 115 updates the response packet based on the number of routers 3 identified in the process of S35 (S56).

Specifically, the packet updating unit 115 sets TTL of the response packet to the value obtained by adding “1” to the number identified in the process of S35. Accordingly, in the case where the first packet is transmitted from the user terminal 4a, the packet updating unit 115 sets TTL of the response packet to “5” obtained by adding “1” to “4”, which is the minimum number of routers 3 that the response packet has to pass through to reach the user terminal 4a. This enables the packet updating unit 115 to cause the response packet to reach the user terminal 4a only when the response packet passes through the shortest route.

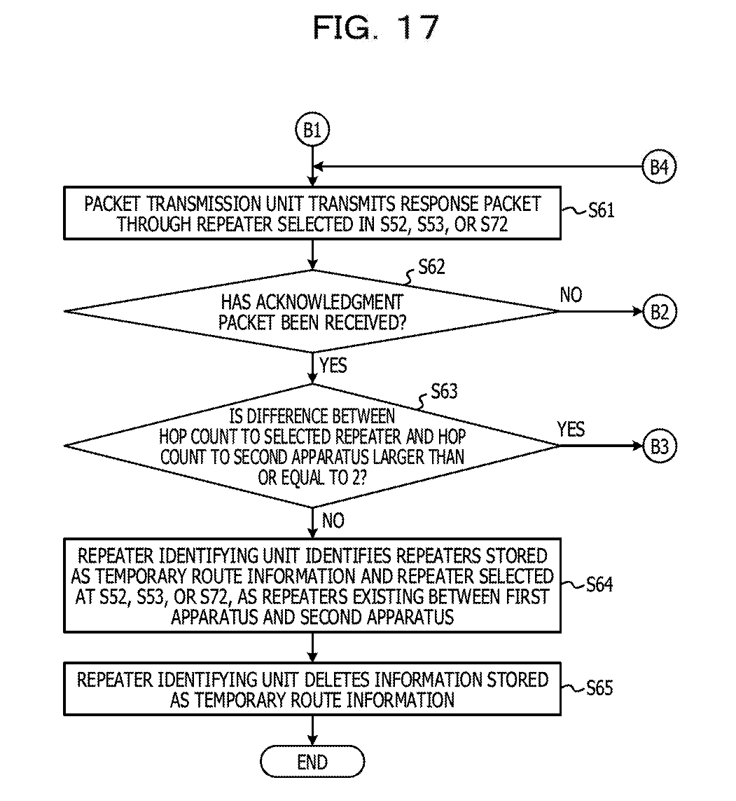

Next, as illustrated in FIG. 17, the packet transmission unit 116 transmits the response packet toward the user terminal 4a in response to the instruction from the repeater identifying unit 117 through the routers 3 selected in the process of S52, S53, or S72 (S61). The process of S72 is described later.

Specifically, in the case where the router 3d is selected in the process of S52, S53, or S72, the packet transmission unit 116 transmits the response packet through the router 3d. Note that the packet transmission unit 116 may create transmission information (not illustrated) in which information indicating the routers 3 that transmitted response packets have already passed through is accumulated.

After that, in the case where the packet reception unit 111 receives the ACK packet from the user terminal 4a (the ACK packet to the response packet transmitted in the process of S61) (YES at S62), the repeater identifying unit 117 determines whether or not all the routers 3 existing between the server apparatus 2 and the user terminal 4a have been identified. Specifically, the repeater identifying unit 117, for example, determines whether or not the difference between the hop count from the server apparatus 2 to the router 3 selected as the router to relay the response and the hop count from the server apparatus 2 to the user terminal 4a is larger than or equal to 2 (S63).

In other words, in the case where the repeater identifying unit 117 receives the ACK packet from the user terminal 4a, the repeater identifying unit 117 determines that the routers 3 that the response packet transmitted in the process of S61 passed through is the routers existing between the server apparatus 2 and the user terminal 4a. For this reason, the repeater identifying unit 117, in this case, determines whether or not all the routers 3 existing between the server apparatus 2 and the user terminal 4a have been identified.

Note that in the case where the difference between the hop count to the router 3 selected as a router to relay the response packet and the hop count to the user terminal 4a is equal to 1, it is possible for the repeater identifying unit 117 to determine that the selected router 3 and the user terminal 4a are disposed in the same segment. Accordingly, by determining whether or not the difference in the hop count between the selected router 3 and the user terminal 4a is larger than or equal to 2, the repeater identifying unit 117 determines whether or not all the routers 3 existing between the server apparatus 2 and the user terminal 4a have been identified.

Then, in the process of S63, in the case the difference in the hop count is not larger than or equal to 2 (NO at S63), the repeater identifying unit 117 identify the routers 3 the information on which is stored in the temporary route information 133 as all the routers 3 existing between the server apparatus 2 and the user terminal 4a. In addition, the repeater identifying unit 117, in this case, identifies the routers 3, each selected in the process of S52, S53, or S72 as a router to relay the response packet, as all the routers 3 existing the server apparatus 2 and the user terminal 4a (S64). In other words, in this case, the repeater identifying unit 117 determines that all the routers 3 existing between the server apparatus 2 and the user terminal 4a have been identified.

After that, as all the routers 3 existing between the server apparatus 2 and the user terminal 4a have been identified, the repeater identifying unit 117 deletes the information stored as temporary route information 133 (S65). Then, the repeater identifying unit 117 terminates the repeater identifying processing.

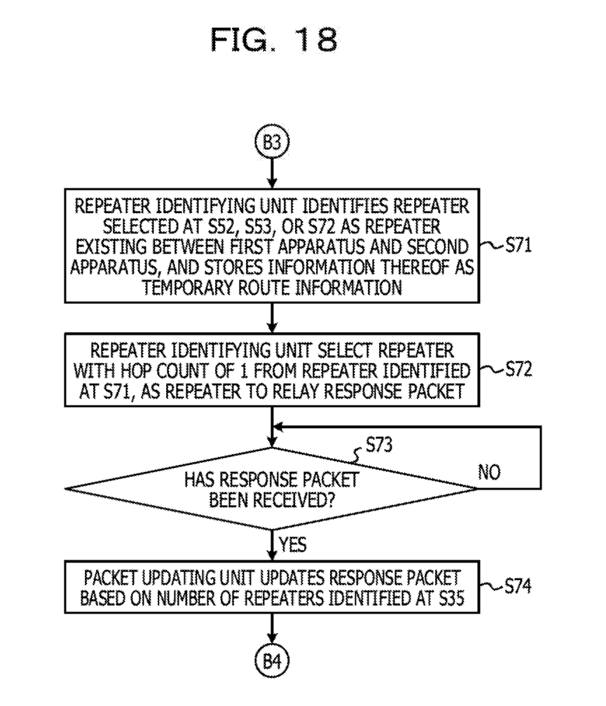

On the other hand, in the case where the difference in the hop count is larger than or equal to 2 (YES at S63), the repeater identifying unit 117 identifies the router 3, selected in the process of S52, S53, or S72 as a router to relay the response packet, as a router 3 existing between the server apparatus 2 and the user terminal 4a, as illustrated in FIG. 18. Then, in this case, the repeater identifying unit 117 stores information on the identified router 3 as temporary route information (S71). After that, the repeater identifying unit 117 select a router with a hop count of 1 from the router 3 identified as a router to relay the response packet in the process of S71 (S72).

In other words, in this case, the repeater identifying unit 117 continues to perform the processing to identify the routers 3 existing between the server apparatus 2 and the user terminal 4a. To do this, the repeater identifying unit 117 has to select in the process of S72 a new router 3 to relay the response packet.

Specifically, the hop count to the router 3d selected in the process of S53 is “3” as illustrated in FIG. 21. On the other hand, the hop count from the server apparatus 2 to the user terminal 4a is “5”. As a result, the repeater identifying unit 117 determines that the difference between the hop count from the server apparatus 2 to the router 3 selected as a router to relay the response packet and the hop count from the server apparatus 2 to the user terminal 4a is larger than or equal to 2 (YES at S63).

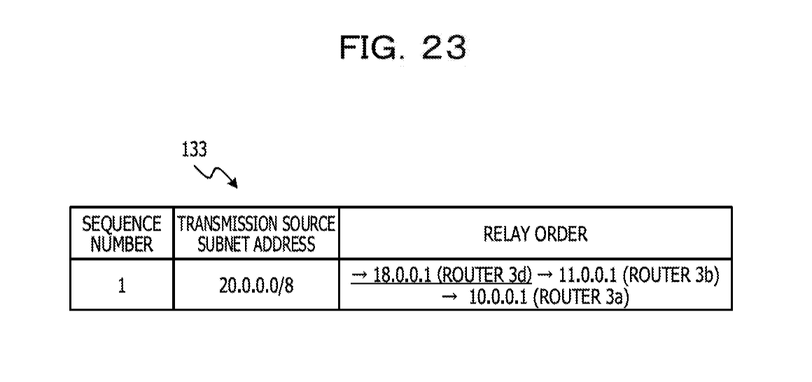

Accordingly, in this case, the repeater identifying unit 117 stores “→18.0.0.1 (router 3d)” indicating the router 3d as indicated at the underlined portion in FIG. 23, as part of the temporary route information 133 (S71). After that, referring to the route information 131, the repeater identifying unit 117 selects, for example, the router 3h with a hop count of “1” from the router 3d, as a router 3 to relay the response packet (S72). Note that the route information 131 illustrated in FIG. 20 does not include information on the router 3g illustrated in FIG. 8 and others. For this reason, it is not possible for the repeater identifying unit 117 to select the router 3g as a router 3 to relay the response packet.

After that, the packet reception unit 111 waits until the packet reception unit 111 receives a new response packet to the next first packet transmitted by the user terminal 4a (NO at S73). Then, in the case the packet reception unit 111 receives a new response packet (YES at S73), the packet updating unit 115 updates the new response packet based on the number of routers 3 identified in the process of S35 in the same way as in the process of S56 (S74).

In other words, in the case where the packet reception unit 111 receives the ACK packet transmitted from the user terminal 4a, the ACK packet is also transmitted to the server apparatus 2 (S37). For this reason, in this case, the processing for the response packet that the server apparatus 2 transmitted to the user terminal 4a has been completed. Accordingly, in this case, the repeater identifying unit 117 waits until the monitor apparatus 1 receives a new response packet responding to the next first packet transmitted from the user terminal 4a. Then, the repeater identifying unit 117 continues to perform the repeater identifying processing using the new response packet.

Note that the information included in the hop count information 132 explained with FIG. 21 is information on a route-by-route basis. For this reason, in the case where the packet reception unit 111 receives in the process of S73 a packet from a user terminal 4 the route from which to the server apparatus 2 is the same as that from the user terminal 4a, the packet reception unit 111 may perform S74 and the subsequent processes using the packet.

After that, the repeater identifying unit 117 performs S61 and the subsequent processes again until the repeater identifying processing is finished.

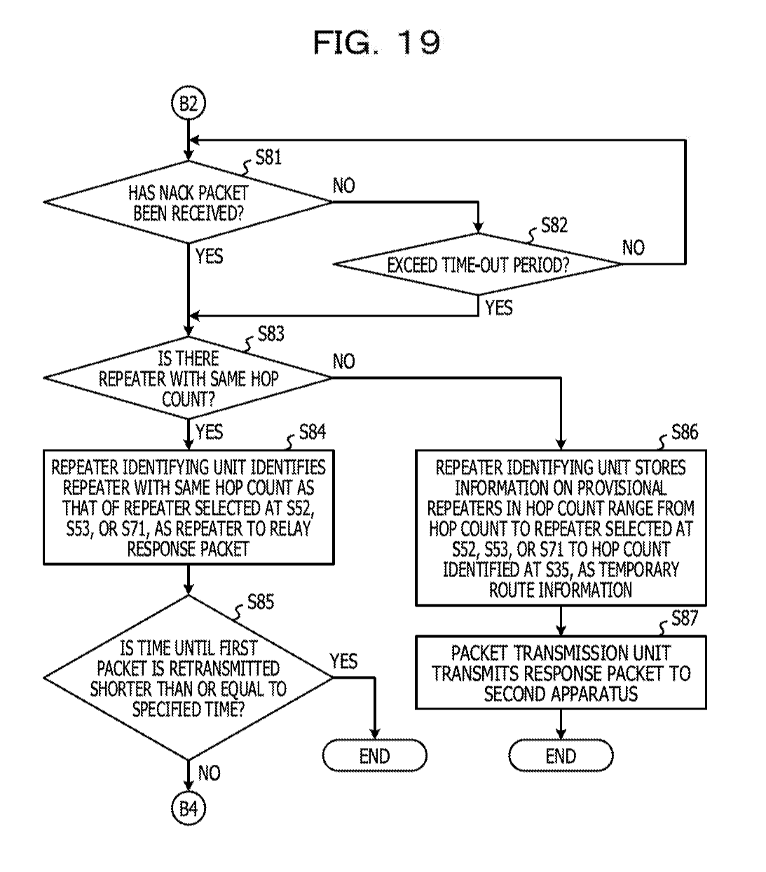

Meanwhile, in the case the monitor apparatus 1 receives a NACK packet from the user terminal 4a or the like (NO at S62, YES at S81), the repeater identifying unit 117, as illustrated in FIG. 19, determines whether or not there is a router 3 with the same hop count from the server apparatus 2 as that of the router 3 selected in the process of S52, S53, or S72 (S83).

Specifically, in the example illustrated in FIG. 8 and others, the user terminal 4a is not on the route continued ahead of the router 3h. For this reason, the response packet transmitted in the process of S61 does not reach the user terminal 4a. Accordingly, in this case, the packet reception unit 111 receives the retransmitted first packet (the NACK packet) (YES at S81).

As a result, it is possible for the repeater identifying unit 117 to determine that the router 3h (the router 3 selected in the process of S52, S53, or S72) is not a router existing between the server apparatus 2 and the user terminal 4a. Accordingly, the repeater identifying unit 117 continues to identify the routers existing between the server apparatus 2 and the user terminal 4a.

Note that in the case where it is not possible to receive the NACK packet from the user terminals 4 or the like (NO at S62, NO at S81), the repeater identifying unit 117 waits until a predetermined time-out period has passed after the response packet is transmitted toward the user terminal 4a (NO at S82). Then, even in the case where the monitor apparatus 1 does not received the NACK packet transmitted from the user terminal 4 or the like as a result of waiting until the predetermined time-out period has passed after the response packet is transmitted toward the user terminal 4a (YES at S82), the repeater identifying unit 117 also performs the process of S83.

In the process of S83, the repeater identifying unit 117 may refer to the transmission information described in the process of S61. Then, the repeater identifying unit 117 may determine whether or not there is a router 3 with the same hop count as that of the router 3 selected in the process of S52, S53, or S72, among the routers 3 that the response packets already transmitted have not passed through (S83). In this way, the repeater identifying unit 117 may keep a response packet from being transmitted again through a router 3 that the response packets already transmitted have passed through.

Then, in the case where it has been determined as a result of the process of S83 that there is a router 3 with the same hop count from the server apparatus 2 (YES at S83), the repeater identifying unit 117 identifies the router 3 with the same hop count as that to the router 3 selected at S52, S53, or S72 as a router to relay the response packet (S84).

Note that in the case where the process of S84 is performed, the ACK packet to the response packet transmitted in the process of S61 has not yet been transmitted to the server apparatus 2. For this reason, in this case, the repeater identifying unit 117 continues to perform the repeater identifying processing using the response packet transmitted in the process of S61. This makes it possible for the repeater identifying unit 117 to continue to perform the repeater identifying processing while waiting transmission of the ACK packet to the response packet transmitted in the process of S61.

Then, after the process of S84, the repeater identifying unit 117, for example, determines whether or not the time until the user terminal 4a retransmits the first packet is shorter than or equal to a specified time (100 (ms), for example) (S85). Specifically, the repeater identifying unit 117, for example, retrieves in advance, information indicating time intervals at which each user terminal 4 retransmits a packet. Then, the repeater identifying unit 117 determines whether or not the time until the user terminal 4a retransmits the first packet is shorter than or equal to the specified time, for example, by referring to the retrieved information.

As a result, in the case where the time until the user terminal 4a retransmits the first packet is shorter than or equal to the specified time (YES at S85), the repeater identifying unit 117 terminates the repeater identifying processing. This makes it possible for the repeater identifying unit 117 to keep the first packet from being retransmitted by the user terminal 4a, and therefore to keep the route search processing from affecting other processing running in the user terminal 4a.

After that, the repeater identifying unit 117 performs S61 and the subsequent processes again until the repeater identifying processing is finished.

On the other hand, in the case where it has been determined that there is not a router 3 with the same hop count from the server apparatus 2 (NO at S83), the repeater identifying unit 117 determines that there is a router 3 the information on which is not included in the route information 133 (hereinafter also referred to as a provisional router 3 or a provisional repeater 3). Then, in this case, the repeater identifying unit 117 stores information on the provisional routers 3 in a hop count range from the hop count of the router 3 selected in the process of S52, S53, or S72 to the hop count identified in the process of S35, as the temporary route information 133 (S86).

In other words, in the case where the ACK packet is not transmitted from all the routers 3 with the hop count of “1” from the router 3 having the largest hop count from the server apparatus 2, among the routers 3 the information on which is included in the temporary route information 133, it means that the route information 133 does not include information on all the routers 3 existing between the server apparatus 2 and the user terminal 4a. For this reason, in this case, the repeater identifying unit 117 determines that there is a provisional router 3 the information on which is not included in the route information 133, as a router 3 with a hop count of “1” from a router 3, the information on which is included in the temporary route information 133 and which has the largest hop count from the server apparatus 2.

This makes it possible for the repeater identifying unit 117 to also identify the existence of the routers the information on which is not available, among the routers 3 existing the server apparatus 2 and the user terminal 4a. Then, the information creation unit 112, as described later, also stores the information on the routers the information on which is not available into the information storing region 130 as part of the route information 133. Thus, for example, even in the case where a failure occurs in a network including routers the information on which is not available, it is possible for the business operator to identify where the failure has occurred or do other related activities by referring to the route information 133.

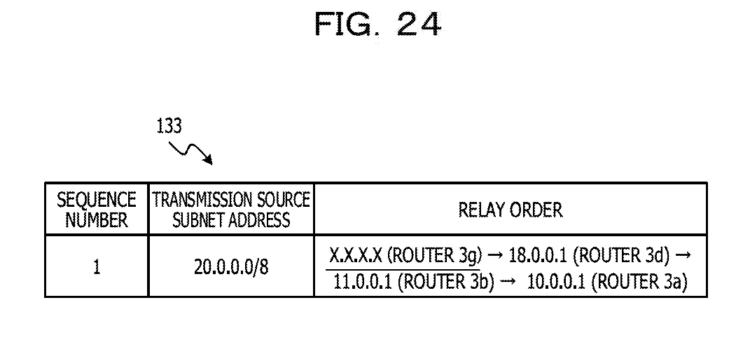

Specifically, the route information 131 illustrated in FIG. 20 does not include information on a router that is directly coupled to the router 3d and has the same hop count as that of the router 3h (S83). Accordingly, the repeater identifying unit 117 stores information on a provisional router 3g, which is a router directly coupled to the router 3d and having the same hop count as that to the router 3h (a router with the IP address of “X.X.X.X”), into the information storing region 130 as part of the temporary route information 133, as illustrated in FIG. 24.

Note that in the case where the difference between the hop count to the router 3 selected at S52, S53, or S72 and the hop count from the server apparatus 2 to the user terminal 4a is larger than or equal to 2, the repeater identifying unit 117 stores information on two or more provisional routers 3 into the information storing region 130 as part of the temporary route information 133.

After the process of S86, the packet transmission unit 116 transmits the response packet to the user terminal 4a (S87). In other words, in the case where the process of S86 was performed, the server apparatus 2 has not received the ACK packet to the response packet transmitted toward the user terminal 4a in the process of S61. For this reason, the packet transmission unit 116 performing the process of S87 makes it possible for the server apparatus 2 to receive the ACK packet to the response packet transmitted in the process of S61. After that, the repeater identifying unit 117 terminates the repeater identifying processing.

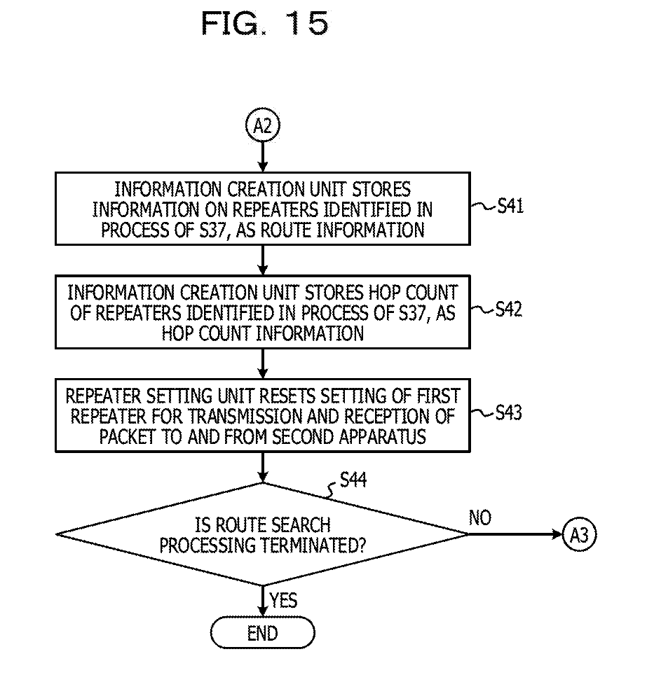

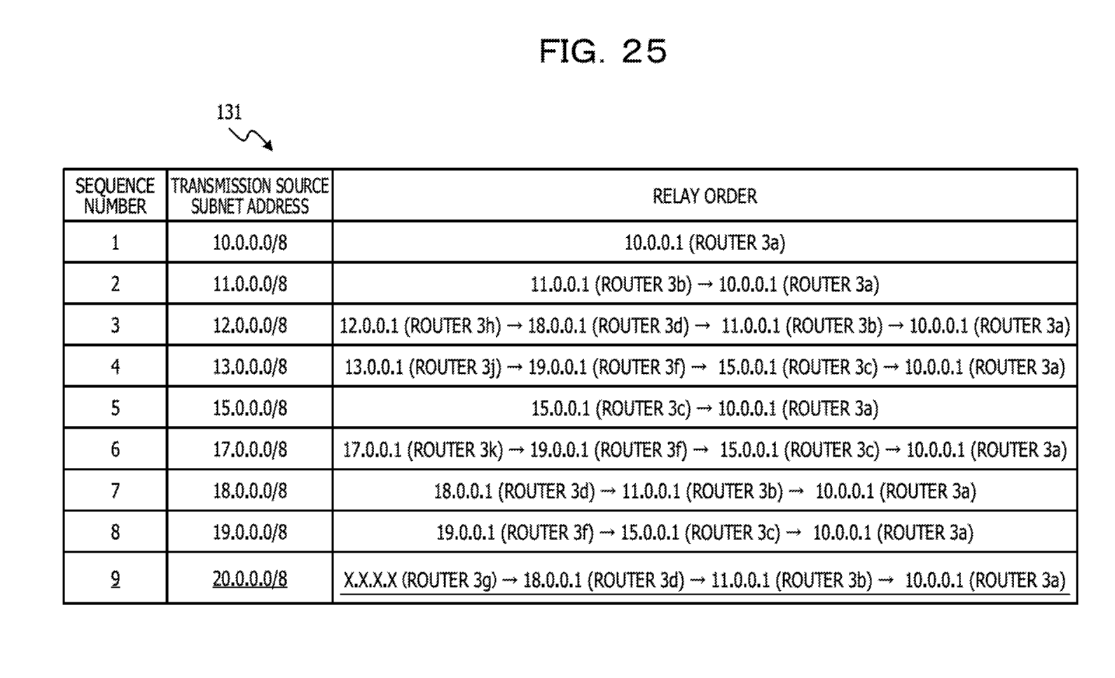

Returning FIG. 14, after the process of S38 is performed, the information creation unit 112 stores the information on the routers 3 identified in the process of S38 into the information storing region 130 as the route information 131, as illustrated in FIG. 15 (S41). Specifically, the information creation unit 112 stores the contents of the temporary route information 133 explained with FIG. 24 as indicated at the underlined portion in FIG. 25 as part of the route information 131.

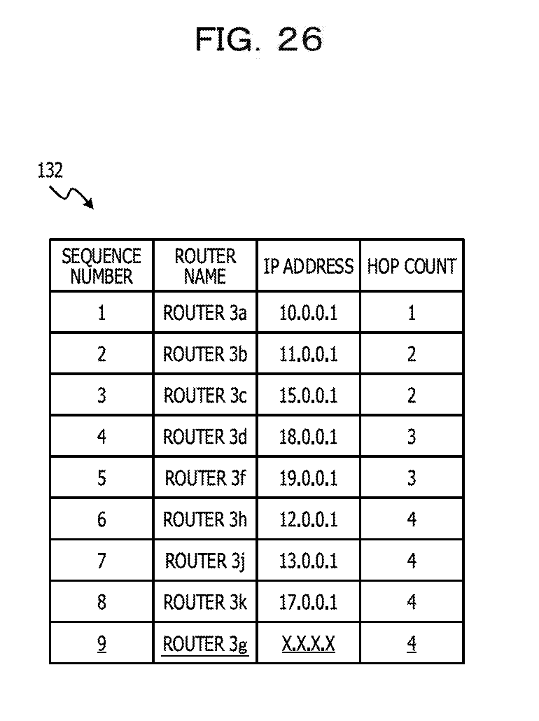

In addition, the information creation unit 112 stores the hop count of each router 3 identified in the process of S38 into the information storing region 130 as the hop count information 132 (S42). Specifically, as indicated at the underlined portion in FIG. 26, the information creation unit 112 stores the hop count of the provisional router 3g explained with FIG. 24 (the value “4” which is equal to the hop count of the router 3h) as part of the hop count information 132.

After that, the repeater setting unit 114 resets the setting of the router 3a for transmission and reception of the response packet to and from the user terminal 4a (S43). Then, the monitor apparatus 1 terminates the route search processing in the case the route search processing is not continued (YES at S44). On the other hand, in the case the route search processing is continued (NO at S44), the monitor apparatus 1 performs S31 and the subsequent processes again.

Note that in the example illustrated in FIG. 26 and others, in the case where it is possible to determine that the subnet address of the router 3g is “20.0.0.0/8”, which is the same as that of the user terminal 4a, the information creation unit 112 may temporarily determine that the IP address of the router 3g is an IP address included in“20.0.0.0/8” (20.0.0.1, for example). Then, the information creation unit 112 may create the route information 131 and the hop count information 132 using the IP address temporarily determined.

Next, descriptions are provided for the process of S86 in the case the difference between the hop count to the router 3 selected in S52, S53, or S72 and the hop count from the server apparatus 2 to the user terminal 4a is larger than or equal to 2. In this case, the repeater identifying unit 117 determines that there are two or more provisional routers 3.

Specifically, in the case the user terminal 4c illustrated in FIG. 8 and others transmits the first packet toward the server apparatus 2, the repeater identifying unit 117 in the process of S86 identifies the existence of a provisional router 3e with a hop count of “3” from the server apparatus 2, which is the same as the hop count of the router 3d. In addition, because the hop count identified in the process of S35 is “4”, in this case, the repeater identifying unit 117 in the process of S86 further identifies the existence of a provisional router 3i with a hop count of “4” from the server apparatus 2.

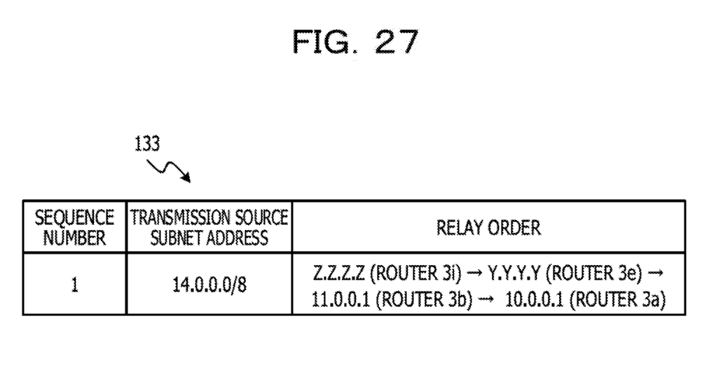

Accordingly, the repeater identifying unit 117, for example, sets “14.0.0.0/8” into the “transmission source subnet address” of the information with the “sequence number” of “1” and sets “Z.Z.Z.Z (router 3i)→Y.Y.Y.Y (router 3e)→11.0.0.1 (router 3b)→10.0.0.1 (router 3a)” into the “relay order”, as illustrated in the temporary route information 133 in FIG. 27 (S86).

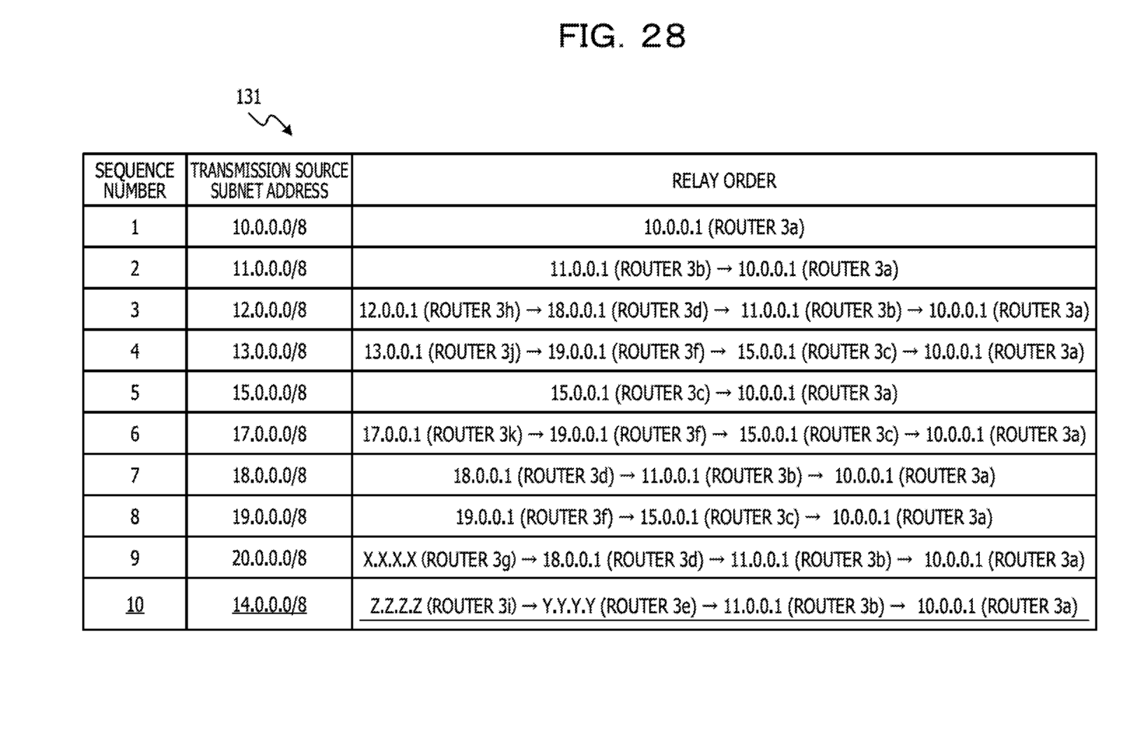

After that, as indicated at the underlined portion in the route information 131 of FIG. 28, the information creation unit 112 sets, for example, the information of the same contents as in the temporary route information 133 illustrated in FIG. 27 as the information with the “sequence number” of “10” (S41).

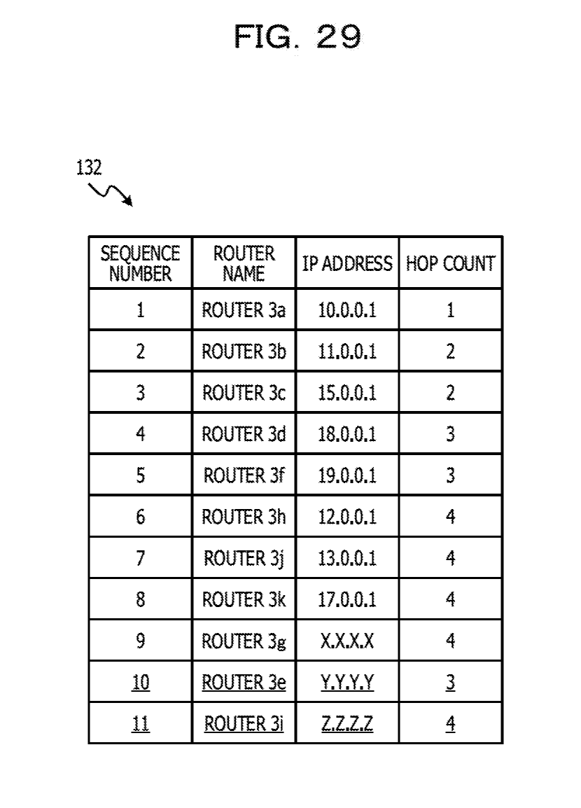

In addition, as indicated at the underlined portion in the hop count information 132 of FIG. 29, the information creation unit 112 sets “router 3e” into the “router name” of the information with the “sequence number” of “10”, “Y.Y.Y.Y” into the “IP address”, “3” into “the hop count”, for example. Moreover, as indicated at the underlined portion in the hop count information 132 of FIG. 29, the information creation unit 112 sets “router 3i” into the “router name” of the information with the “sequence number” of “11”, “Z.Z.Z.Z” into the “IP address”, and “4” into “the hop count”, for example (S42).

Even in the case where the difference in the hop count is larger than or equal to 2 in the process of S86, it is possible for the repeater identifying unit 117 to identify the existence of routers 3 the information on which is not available.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A method using a first information processing apparatus, a second information processing apparatus, a plurality of routers that relay a packet between the first information processing apparatus and the second information processing apparatus, and an apparatus coupled to a first router included in the plurality of routers, the method comprising:
relaying, by the first router, a first packet transmitted from the first information processing apparatus to the second information processing apparatus;
identifying, by the apparatus, a first value indicating a number of routers for the first packet to pass through before reaching the second information processing apparatus;
receiving, by the first router, a second packet transmitted from the second information processing apparatus to the first information processing apparatus;
setting, by the apparatus, into the second packet, based on the first value, a second value indicating an allowable number of the routers for the second packet to pass through;
transmitting, by the first router, the second packet in which the second value is set, to a second router that is included in the plurality of routers and coupled to the first router;
transmitting, by the first information processing apparatus, an acknowledgement packet for the second packet when the second packet reaches the first information processing apparatus;
receiving, by the first router, the acknowledgement packet; and
identifying, by the apparatus, the second router as a router that the first packet passed through, based on the acknowledgement packet.

2. The method according to claim 1, further comprising:
retransmitting, by the second information processing apparatus, the second packet when the acknowledgement packet is not issued;
receiving, by the first router, the retransmitted second packet;
setting, by the apparatus, into the retransmitted second packet, the second value;
transmitting, by the first router, the retransmitted second packet in which the second value is set, to a third router that is included in the plurality of routers, coupled to the first router, and different from the second router; and
identifying, by the apparatus, the third router as the router that the first packet passed through when the acknowledgement packet is issued to the retransmitted second packet.

3. The method according to claim 1, further comprising:
when the number of routers that the second packet passed through reaches the second value, not transmitting the second packet to another router included in the plurality of routers.

4. The method according to claim 1, wherein the identifying the first value is executed based on information included in a header of the first packet.

5. The method according to claim 1, wherein the hop count between the first router and the second information processing apparatus is one.

6. The method according to claim 1, further comprising:
when the second packet does not reach the first information processing apparatus, receiving, by the first router, a negative acknowledgement packet.

7. The method according to claim 6, further comprising:
when the second packet which is a response packet to the first packet does not reach the first information processing apparatus, transmitting, by the first information processing apparatus, the negative acknowledgement packet to the second information processing apparatus.

8. The method according to claim 6, further comprising:
when the number of routers that the second packet passed through reaches the second value at a fourth router included in the plurality of router, transmitting, by the fourth router, the negative acknowledgement packet to the second information processing apparatus.

9. The method according to claim 1, wherein
when a connection between the first information processing apparatus and the second information processing apparatus is terminated, the identifying the router that the first packet passed through is stopped, and
when the first router receives a third packet transmitted from the first information processing apparatus to the second information processing apparatus, the identifying the router that the first packet passed through resumes.

10. The method according to claim 2, wherein
when a time interval at which the second information processing apparatus retransmits the second packet becomes shorter than or equal to a specified time, the identifying the router that the first packet passed through is stopped, and
when the first router receives a fourth packet transmitted from the first information processing apparatus to the second information processing apparatus, the identifying the router that the first packet passed through resumes.

11. The method according to claim 1, wherein the second value is equal to the first value.

12. The method according to claim 1, further comprising:
outputting route information indicating that the first packet passed through the second packet, from the apparatus.

13. An apparatus configured to be coupled to a first router included in a plurality of routers that relay a packet between the first information processing apparatus and the second information processing apparatus, the apparatus comprising:
a memory; and
a processor coupled to the memory and configured to:
when the first router relays a first packet transmitted from the first information processing apparatus to the second information processing apparatus, identify a first value indicating a number of routers for the first packet to pass through before reaching the second information processing apparatus,
when the first router receives a second packet transmitted from the second information processing apparatus to the first information processing apparatus, set, into the second packet, based on the first value, a second value indicating an allowable number of the routers for the second packet to pass through, and
when the first router transmits the second packet in which the second value is set to a second router that is included in the plurality of routers and coupled to the first router, and the first information processing apparatus transmits an acknowledgement packet for the second packet after the second packet reaches the first information processing apparatus, and the first router receives the acknowledgement packet, identify the second router as a router that the first packet passed through, based on the acknowledgement packet.

14. The apparatus according to claim 13, wherein
the second information processing apparatus retransmits the second packet when the acknowledgement packet is not issued,
the first router receives the retransmitted second packet, and transmits the retransmitted second packet in which the second value is set, to a third router that is included in the plurality of routers, coupled to the first router, and different from the second router, and
the processor is further configured to:
set, into the retransmitted second packet, the second value, and
identify the third router as the router that the first packet passed through when the acknowledgement packet is issued to the retransmitted second packet.

15. The apparatus according to claim 13, wherein when the number of routers that the second packet passed through reaches the second value, the second packet is not transmitted to another router included in the plurality of routers.

16. The apparatus according to claim 13, wherein the identifying the first value is executed based on information included in a header of the first packet.

17. A non-transitory computer-readable storage medium storing a program that causes an information processing apparatus to execute a process, the process comprising:
when a first router relays a first packet transmitted from a first information processing apparatus to a second information processing apparatus, identifying a first value indicating a number of routers for the first packet to pass through before reaching the second information processing apparatus, the first router being included in a plurality of routers that relay a packet between the first information processing apparatus and the second information processing apparatus;
when the first router receives a second packet transmitted from the second information processing apparatus to the first information processing apparatus, setting, into the second packet, based on the first value, a second value indicating an allowable number of the routers for the second packet to pass through; and
when the first router transmits the second packet in which the second value is set to a second router that is included in the plurality of routers and coupled to the first router, and the first information processing apparatus transmits an acknowledgement packet for the second packet after the second packet reaches the first information processing apparatus, and the first router receives the acknowledgement packet, identifying the second router as a router that the first packet passed through, based on the acknowledgement packet.

18. The non-transitory computer-readable storage medium according to claim 17, wherein
the second information processing apparatus retransmits the second packet when the acknowledgement packet is not issued,
the first router receives the retransmitted second packet, and transmits the retransmitted second packet in which the second value is set, to a third router that is included in the plurality of routers, coupled to the first router, and different from the second router, and
the process further comprises:
setting, into the retransmitted second packet, the second value; and
identifying the third router as the router that the first packet passed through when the acknowledgement packet is issued to the retransmitted second packet.

19. The non-transitory computer-readable storage medium according to claim 17, the process comprising:
when the number of routers that the second packet passed through reaches the second value, not transmitting the second packet to another router included in the plurality of routers.

20. The non-transitory computer-readable storage medium according to claim 17, wherein the identifying the first value is executed based on information included in a header of the first packet.
